(19) United States
(12) Patent Application Publication
(10) Pub. No.: US 2025/0369639 A1
(43) Pub. Date: Dec. 4, 2025

(54) OPTIMIZATION OF BUILDING OPERATIONS

(71) Applicant: Honeywell International Inc., Charlotte, NC (US)

(72) Inventors: Karel Marik, Revnice (CZ); Petr Endel, Praha (CZ); Michal Vrana, Studnice (CZ)

(21) Appl. No.: 18/679,517

(22) Filed: May 31, 2024

(51) Int. Cl. F24F 11/46; G05B 13/02

(52) U.S. Cl. CPC F24F 11/46; G05B 13/021

(57) ABSTRACT

Examples techniques to manage building operations are described. A first range of setpoints, a second range of setpoints, and a third range of setpoints of an asset installed in a building is determined. Current setpoints for operating parameters of the asset which are determined by a building operations optimizer are monitored. If the current setpoints determined by building operations optimizer fall within the second range of setpoints or the third range of setpoints, the current setpoints are adjusted by controlling a local controller to bring the current setpoint back into the first range of setpoints that correspond to values of the operating parameters of the asset in accordance with predefined optimal operating conditions for the asset, thereby ensuring safety of the asset and comfort to occupants of the building.

### BACKGROUND

Sustainable building operations are increasingly recognized as an important aspect of modern construction and facility management due to their impact on the environment, economy, and social well-being. Buildings are a substantial contributor to global energy consumption and greenhouse gas emissions, with large buildings such as offices, hospitals, and hotels accounting for a considerable share. As such, there is a pressing demand to operate these structures in a manner that is environmentally responsible, energy-efficient, and sustainable over the long term. Sustainable building operations help in minimizing energy consumption and emissions, conserving natural resources, and promoting biodiversity. For example, an energy-efficient building lowers operational costs, for example, by reducing energy and water usage. This translates into financial savings for building owners and occupants and contributes to the economic viability of green building practices. In some cases, optimization of the building operations may become a necessity in order to comply with government regulations and guidelines put in place to promote sustainability in a built environment.

Building Management Systems (BMSs) play an important role in meeting these objectives by enabling more efficient, and safer building operations. The BMSs are advanced control systems that provide centralized management for assets, such as HVAC (heating, ventilation, and air conditioning), lighting, power systems, fire systems, and safety systems, installed in a building.

### SUMMARY

The details of some embodiments of the invention described in this specification are set forth in the accompanying drawings and the description below. Other features, aspects, and advantages of the invention will become apparent from the description, the drawings, and the claims.

The present invention relates to methods, systems, and non-transitory computer-readable media for managing building operations.

According to an aspect of the present invention, a method includes determining a prespecified range of setpoints for operating parameters of an asset installed in a building. The prespecified range of setpoints includes a first range of setpoints, a second range of setpoints, and a third range of setpoints for the asset installed in the building. In the context of building operations, the asset may refer to any equipment or a system that is installed within the building to perform a specific function. In an example, the asset may be a single equipment, such as an air conditioning unit, a boiler, or lighting fixtures. Alternatively, the asset may be a more complex system composed of several separate equipments. For example, a Heating, Ventilation, and Air Conditioning (HVAC) system may be an asset that includes the equipments like chillers, ducts, and thermostats, all functioning simultaneously to regulate temperature and air quality of the building.

The first range of setpoints corresponds to values of operating parameters of the asset in accordance with predefined optimal operating conditions for the asset, for example, defined by a manufacturer of the asset. In an example embodiment of the present subject matter, the first range of setpoints can be regarded as a safe range of setpoints because when actual setpoints of the asset fall within the first range of setpoints, the asset operates safely and does not cause discomfort to occupants of the building. The second range of setpoints corresponds to values of operating parameters of the asset in accordance with predefined sub-optimal operating conditions for the asset. The third range of setpoints corresponds to values of operating parameters of the asset in accordance with predefined unsafe operating conditions for the asset. The predefined optimal operating conditions correspond to conditions under which the asset operates safely.

The operating parameters of the asset may be considered to be within the sub-optimal operating conditions when the operating parameters of the asset do not correspond to the predefined criteria for the optimal operating conditions. The sub-optimal operating conditions are characterized by setpoints of the asset that are not within the first range of setpoints but still within a range that does not compromise the safety or integrity of the asset. The unsafe operating conditions may correspond to scenarios where the operating parameters of the asset go even beyond the sub-optimal operating conditions exceeding predefined safety thresholds, leading to risk to the safety of the asset or discomfort to the occupants of the building.

The method comprises monitoring current setpoints for the asset installed in the building. The current setpoints are defined by a building operations optimizer based on inputs from sensors installed in the building to sense physical conditions pertaining to the building. For example, the current setpoints for the asset is provided by the building operations optimizer to a local controller that operates the asset to comply with the current setpoints.

In accordance with example embodiments of the present subject matter, the current setpoints may be adjusted by controlling the local controller to bring the setpoints of the asset within the first range of setpoints if the current setpoints are identified to be in the third range of setpoints or second range of setpoints. By bringing the setpoints of the asset within the first range of setpoints, undesired occupant discomfort or potential damage to the asset may be prevented.

In accordance with an embodiment of the present invention, the system to manage building operations includes a processor to determine a range of setpoints predefined for an asset installed in a building. The prespecified range of setpoints includes a first range of setpoints, a second range of setpoints, and a third range of setpoints. The first range of setpoints corresponds to values of operating parameters of the asset in accordance with a predefined optimal operating conditions for the asset. The second range of setpoints corresponds to values of operating parameters of the asset in accordance with a predefined sub-optimal operating conditions for the asset. The third range of setpoints corresponds to values of operating parameters of the asset in accordance with a predefined unsafe operating conditions for the asset.

The processor further obtains site data corresponding to an ongoing operation of the asset to identify if a current setpoint of an asset is outside the first range of setpoints. The current setpoint for the asset is determined by a building operations optimizer that is coupled to the asset to operate the asset in accordance with the current setpoint.

In accordance with example embodiments of the present subject matter, when the current setpoint is beyond the first range of setpoints, a corrective action may be applied to bring the current setpoint of the asset within the first range of setpoints. The corrective action may comprise, for example, adjusting the current setpoint, by overriding the building operations optimizer, to bring the current setpoint within the first range of setpoints.

In accordance with an embodiment of the present invention, the non-transitory computer-readable medium contains instructions that enable a processing resource to obtain a current setpoint corresponding to an asset installed in a building to identify if the current setpoint of the asset is within a green zone, a red zone, or a yellow zone. The current setpoint is set by a building operations optimizer of the building. In the green zone, values of operating parameters of the asset correspond to a predefined optimal operating condition for the asset. In the yellow zone, values of the operating parameters correspond to a predefined sub-optimal operating condition for the asset. In the red zone, values of the operating parameters correspond to a predefined unsafe operating condition for the asset. In an example, the instructions are executable to adjust the current setpoint by a local controller to bring the current setpoint within the green zone if the current setpoint is identified to be in the red zone or the yellow zone. To adjust the current setpoint, the local controller may be operated independently of the building operations optimizer.

Embodiments of the present invention ensure that assets installed in the building function within the safe range of setpoints that corresponds to the values of the operating parameters of the asset in accordance with the predefined optimal operating conditions for the asset, thus preventing harm to these assets. By avoiding the setpoints for the assets that may lead to unsafe operating conditions, for example, those within the red or yellow zones, the present invention enables the safe operation and durability of the assets of the building.

Also, by applying specific rules of operation of the assets in different zones, the present invention maintains the setpoints for the assets that are conducive to the comfort of the occupant of the building. This means that even if the building operations optimizer suggests setpoints that may cause damage to the assets, for instance owing to a malfunction in the remote building operations, the present subject matter provides to adjust the setpoints suggested by the building operations optimizer, thereby ensuring safety and durability of the assets.

Additional features and advantages are realized through the concepts of the present invention. Other embodiments and aspects of the invention are described in detail herein and are considered a part of the claimed invention.

### BRIEF DESCRIPTION OF FIGURES

The following detailed description references the drawings, wherein:

FIG. 1 illustrates a network environment for implementing example techniques to manage building operations, in accordance with an example implementation of the present invention;

FIG. 2 illustrates a system to manage building operations, in accordance with an example implementation of the present invention;

FIG. 3 illustrates the system to manage building operations, in accordance with another example implementation of the present subject matter;

FIG. 3a illustrates a chart depicting categorization of a prespecified range of setpoints in a set of limits, in accordance with another example implementation of the present subject matter;

FIG. 4 illustrates an exemplary interface for providing a zone of operation of an asset of a building to a user in real-time, in accordance with an example implementation of the present invention;

FIG. 5 illustrates a signal flow in a process to manage building operations, in accordance with an example implementation of the present subject matter;

FIG. 6 illustrates a method for managing building operations, in accordance with an example implementation of the present invention;

FIG. 7 illustrates a flow diagram of a process of managing setpoint changes in operating parameters of assets installed in a building, according to an example implementation of the present subject matter.

FIG. 8 illustrates a flow diagram of a process of determining a rate of change of setpoints of the operating parameters of the assets installed in the building, according to an example implementation of the present subject matter;

FIG. 9 illustrates a computing environment for managing building operations, according to an example implementation of the present invention.

In the figures, the left-most digit(s) of a reference number identifies the figure in which the reference number first appears. The same numbers are used throughout the drawings to reference like features and components.

### DETAILED DESCRIPTION

Building Management Systems (BMSs) are implemented to monitor and control assets installed in buildings to create desired controlled conditions in the buildings. A controlled condition of a building may be created in accordance with the purpose that the building is designed to serve. For instance, theaters may need to cater to predefined sound propagation characteristics while warehouses may need to maintain substantially low temperatures for prolonged durations of time and a residential building may need to cater to the comfort and well-being of occupants of the residential building. As the buildings are designed for a wide variety of purposes, the controlled conditions of the buildings, vary significantly to cater to such a wide variety of purposes.

A Building Management System (BMS) comprises a control system that is configured to monitor and regulate the controlled conditions of the building. Control systems may include various assets, for example, an HVAC system, to achieve desired controlled conditions. To achieve the desired controlled conditions, setpoints are defined for operating parameters of the assets.

Herein, the “setpoints” may be understood as predefined values for the operating parameters of the assets to achieve the desired controlled conditions within the building. The setpoints serve as targets for the control system to achieve for maintaining the desired controlled conditions in the building, for example, through regulation of the assets installed in the building. For example, setting a thermostat to 20° C. establishes a temperature setpoint for the HVAC system to operate the HVAC system to achieve and maintain a controlled temperature of the building at 20° C.

The BMS may collect and analyze data from field devices installed throughout the building. The field devices of the BMS may consist of sensors that monitor the operating parameters of the assets and actuators that execute physical changes (e.g., opening valves, switching lights, etc.). The field devices provide real-time data to local controllers, which then adjust the setpoints for the operating parameters of the assets to maintain the desired controlled conditions in the building. The local controllers process the data collected by the sensors to make decisions regarding the setpoints of the operating parameters of the assets connected with the sensors and then send commands to the actuators to adjust the operating parameters accordingly, to achieve the desired controlled conditions based on the operation of the assets of the building.

Generally, the control systems provide a uniform output that is intended to meet the widest possible range of the controlled conditions. This generalized approach of the conventional control systems results in inefficiencies due to a lack of responsiveness to real-time data and changing environmental or operational conditions. For example, the HVAC system, which is responsible for maintaining a comfortable climate in the building, in a conventional setup, may be configured to operate within a conservative range of settings. These settings are chosen to ensure that the HVAC system can provide adequate thermal comfort under a variety of operating scenarios, from low to high occupancy and during different weather conditions. However, this conservative approach means that the HVAC system may not scale its operations up or down efficiently in response to the actual demand at any given moment. Consequently, the HVAC system may continuously pump air and water at nearly uniform temperatures and flow rates, regardless of considerations, such as the weather conditions or whether all areas of the building require the same level of heating or cooling. This may lead to situations where all or some parts of the building are over-conditioned, receiving more heating or cooling than is actually needed, while other parts might be under-conditioned. The result of this lack of responsiveness is that energy is not utilized as effectively as it should be, and this creates an opportunity for savings.

To overcome such drawbacks, a building operations optimizer or system-level optimizer (hereinafter optimizer) is generally used. The optimizer performs dynamic adjustments of the setpoints of the operating parameters of the assets of the building in response to real-time data collected from the sensors corresponding to weather conditions and actual occupancy of the building.

By doing so, the optimizer ensures that the energy is utilized in the building as efficiently as possible while maintaining comfort in all areas of the building. To accomplish this, the optimizer periodically updates the setpoints of the operating parameters of the assets of the building that govern the operation of the assets in the building. As discussed above, the setpoints are target values for various operating parameters of the building, such as the temperature, the flow rates, etc., that the control system of the building aims to maintain. By adjusting these setpoints at regular intervals, such as every 15 minutes, 2 hours, month, or season, the optimizer can ensure that the operations of the assets of the building align with current conditions and requirements. This periodic adjustment in the setpoints of the operating parameters of the assets allows the optimizer to respond to changes in occupancy, weather, and other factors that influence the energy demands within the building. For instance, if the occupancy of the building decreases, the optimizer can lower the temperature setpoint to reduce heating or cooling output, thereby saving energy while still keeping the environment comfortable for the remaining occupants. Similarly, if the weather changes, the optimizer can adjust the setpoints to account for the new conditions, such as increasing cooling on an unexpectedly hot day.

Thus, the optimizer seeks to address the inefficiency of conventional building management systems by adjusting setpoints in response to real-time data on building occupancy and weather conditions, thereby delivering optimum amount of energy at all times to maintain the desired controlled condition in various areas of a building. The dynamic adjustment of the setpoints by the optimizer enables the optimization of energy by precisely providing the energy at the right times and in the right amounts. This not only ensures that the desired controlled conditions are maintained in the building but also ensures the overall energy efficiency of the building, leading to cost savings, and reduced environmental impact.

The process of adjusting the setpoints for the operating parameters is governed by a range of safety and operational constraints to ensure both the safety of the assets and the comfort of the occupants of the building. Specifically, new values to which the setpoints are updated are confined within a predefined minimum and maximum thresholds. These thresholds are divided into two categories: hard limits and soft limits. The hard limits serve as boundaries that cannot be crossed without risking damage to the assets. The hard limits are generally provided by the manufacturers of the assets. On the other hand, the soft limits refer to a range of the operating parameters, within the hard limits, that may be preferred by a user. For example, in a residential complex, the soft limits for the operating parameters of an HVAC may be selected to prevent discomfort among the occupants of the building and are usually set by the occupants themselves or by a management team of the building. Confining the setpoints of the operating parameters within these hard and soft limits ensures that while the setpoints are updated to optimize the controlled conditions of the building, the setpoints do not compromise the safety of the assets or the comfort of the occupants of the building.

Despite the capabilities of the optimizer to dynamically adjust the setpoints of the assets based on actual building occupancy and weather conditions, there are instances where unpredictable site conditions, temporarily compromised sensors, or disruptions in communication between the local controllers and the optimizer may lead to failures in meeting above-mentioned safety and operational requirements. Such failures may result in considerable issues related to occupant comfort or, in more severe cases, may lead to damage to the assets. Such damages may often result in the assets being repaired or replaced and may lead to significant expenditure. Unpredictable site conditions may include sudden changes in occupancy or environmental conditions that are not immediately reflected in the data received by the optimizer. Additionally, sensor malfunctions or inaccuracies may provide the optimizer with erroneous information, leading to inappropriate setpoint adjustments. Problems in communication between the local controllers with the field devices at a site and a cloud infrastructure hosting the optimizer can accentuate these issues by causing delays in the relay of the real-time data.

For example, an algorithm in the optimizer, especially if it is not fully matured, developed by a third party, or reliant on black-box AI technology, may suggest a setpoint for chilled water temperature that is excessively low or recommend a decrease that is too steep. Such adjustments in the setpoints may lead to surge events in a chiller of the HVAC system, resulting in damage to the chiller. In another example, the optimizer may suggest a setpoint for the chilled water temperature that is too high, leading to the occupant discomfort, particularly, if data corresponding to comfort state of the building is incomplete due to sensing or communication issues. The “comfort state” may refer to the thermal comfort experienced by the occupants of the building. If the optimizer sets the chilled water temperature too high due to incomplete data from the sensing or communication issues, it may result in a condition within the building that is too warm, causing discomfort to the occupants.

Generally, the optimizer may not be configured to resolve situations where erroneous data is received due to sensing or communication problems. As a result, the conventional optimizers may not be able to prevent undesired occupant discomfort or avoid damage to the assets when faced with extreme and incorrect data inputs. Additionally, optimizers are often not robust to data losses and communication issues, which may lead to suboptimal performance or even complete system failures under such conditions.

According to example implementations of the present invention, techniques for managing building operations that optimize building operations are described. The present invention comprises determining a first range of setpoints, a second range of setpoints, and a third range of setpoints for an asset installed in a building. According to an example implementation of the present subject matter, the first range of setpoints corresponds to values of operating parameters of the asset in accordance with a predefined optimal operating conditions for the asset. The second range of setpoints corresponds to values of operating parameters of the asset in accordance with a predefined sub-optimal operating conditions for the asset. The third range of setpoints corresponds to values of operating parameters of the asset in accordance with a predefined unsafe operating conditions for the asset.

In an example, the predefined optimal operating conditions may refer to a specific set of circumstances under which the asset operates safely. For example, in a building, the optimal operating conditions may refer to a state where the setpoints the operating parameters of the asset of the building, such as an HVAC system, are within prespecified ranges that ensure the safety of the HVAC system as the desired controlled condition is achieved and maintained in the building. The operating parameters of the HVAC system may include temperature settings, airflow rates, and humidity levels. When actual measured values of the operating parameters of the HVAC system, such as current temperature, airflow, and humidity correspond to the prespecified ranges, the HVAC system is considered to be functioning under the optimal operating conditions.

In another example, the operating parameters of the asset are considered to be within the sub-optimal operating conditions when the setpoints of the operating parameters of the asset do not correspond to the prespecified ranges for the optimal operating conditions. The sub-optimal operating conditions are characterized by the setpoints of the asset that are not within the first range of setpoints but still within a range that does not compromise the safety of the asset. For example, in the building, the sub-optimal operating conditions may arise when the setpoints of the operating parameters of the asset of the building, such as the temperature setting, airflow rate, and humidity levels of the HVAC system deviate from their prespecified ranges that ensure the safety of the HVAC system. When the setpoints of the operating parameters of the asset fall outside of the prespecified ranges that ensure the safety of the asset, for example, the first setpoint ranges, but remain within predefined safety thresholds that do not endanger the safety of the asset of the building, the asset is considered to be functioning under the sub-optimal operating conditions.

In yet another example, the unsafe operating conditions may refer to scenarios where the setpoints of the operating parameters of the asset go even beyond the sub-optimal operating conditions exceeding the predefined safety thresholds, leading to a potential risk to the safety of the asset. Thus, the unsafe operating conditions are characterized by setpoints of the operating parameters of the asset that fall outside of the predefined safety thresholds, which are put in place to prevent asset damage.

According to an example implementation of the present subject matter, current setpoints for the asset installed in the building are monitored. The current setpoints are determined by a building operations optimizer based on inputs from sensors installed in the building to sense physical conditions pertaining to the building. The current setpoints for the asset is provided by the building operations optimizer to a local controller that operates the asset to comply with the current setpoints. Based on the monitoring, the current setpoints of the asset are adjusted by controlling the local controller to bring the setpoints of the asset within the first range of setpoints if the current setpoints are identified to be in the third range of setpoints or the second range of setpoints. By bringing the setpoints of the asset within the first range of setpoints, the possibility of damage to the asset or undesired occupants may be prevented. Additionally, the present subject matter allows for controlling rate and extent of changes in the setpoints to avoid abrupt adjustments in the setpoints, thereby preventing damage to the asset and/or discomfort to the occupant.

Thus, by enforcing limits on changing the setpoints for the operating parameters of the assets, it is ensured that the controlled conditions are achieved and maintained while also protecting the physical infrastructure, such as the assets of the building, from extreme conditions that may lead to premature wear or failure of the assets.

In accordance with example embodiments of the present subject matter, the system for managing building operations described herein serves as an intermediary between the field devices and the building operations optimizer, resolving safety issues that arise from the interaction between field devices and the building operations optimizer, thereby maintaining a secure and efficient building operation optimization process.

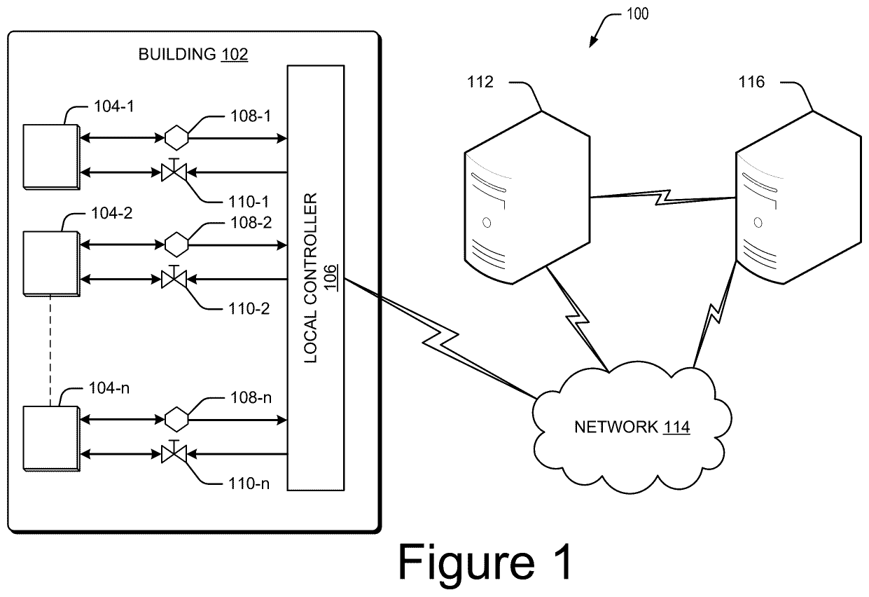

The above techniques are further described with reference to FIG. 1 to FIG. 9. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment for implementing examples techniques for managing building operations, in accordance with an example implementation of the present invention.

Building operations are carried out in buildings, such as commercial offices, malls, hotels, hospitals, residential complexes, or educational institutions, to create controlled conditions within the buildings for various purposes, often, while addressing additional requirements, such as cost-efficient and sustainable operation of the buildings. As the buildings are designed for a wide variety of purposes, the controlled conditions of the buildings vary significantly to cater to the respective purposes.

In a building 102, one or more assets 104-1, 104-2, . . . , and 104-n (hereinafter asset 104-1), operate in conjunction with each other to achieve and maintain the controlled conditions within the building 102. A controlled condition of the building 102 may refer to a physical condition within the building 102 that is created to serve a purpose in the building 102. For example, in the context of a residential complex, one or more controlled conditions may be created in accordance with the comfort of the occupants of the building. For instance, the physical conditions may comprise lighting, temperature, air quality, and humidity in the building.

The controlled conditions within the building 102 are achieved by controlling operating parameters of the asset 104-1 of the building 102. In an example, the operating parameters, such as temperature and airflow settings of the asset 104-1, such as HVAC systems installed in the building 102 may be regulated to create and maintain one or more controlled conditions in accordance with demands from the occupants thereof.

An asset may refer to any equipment or a collection of equipments that functions to create and maintain one or more controlled conditions in a building. An asset, for example, maybe a single unit of an HVAC system, such as an air handler or boiler, to a subsystem like the HVAC system itself, which may comprise multiple equipments working together to maintain the controlled conditions in the building. The term “asset” may also extend to other control systems of the building 102, such as security systems, lighting systems, fire control systems, and/or other building control systems installed within the building, each of which may consist of individual equipment or integrated sets of equipment.

The asset 104-1 of the building 102 is managed such that achieving and maintaining the controlled conditions of the building 102 also account for a safe operation of the asset 104-1 that brings about said controlled conditions. Thus, the asset 104-1 to be installed in the building 102 is selected bearing the purpose of the building in mind. In other words, the asset 104-1 is selected such that the controlled conditions required to serve the purpose of the building 102 are achieved by operating the asset 104-1 in accordance with its safe limits of operation.

For example, a cooling system for a laboratory that may need to be maintained at temperatures lower than that required in a residential complex may be selected based on its correspondingly higher cooling capacity. As will be understood, installing a cooling system suitable for the residential complex in the laboratory, where it may be operated to achieve temperatures lower than may have been designed to achieve, may damage the cooling system. In extreme circumstances, such unsafe operation of the cooling system may also lead to fire incidences due to overheating of components of the cooling system and other safety hazards.

Thus, to ensure that the controlled conditions of the building account for the safety of the asset 104-1, values of the operating parameters of the asset 104-1 are maintained within predefined safe limits of the operating parameters. In an example, the predefined safe limits of the operating parameters for the asset 104-1 may be defined by a manufacturer of the asset 104-1, for example, based on a rated capacity, design, and other factors relating to the performance capability of the asset 104-1 to prevent malfunctions or damage to the asset 104-1 during its installation and operation in the building 102.

As discussed previously, maintaining desired controlled conditions in a building involves regulating the controlled conditions regularly based on changes in factors that influence the controlled conditions. For example, maintaining desired controlled conditions in a building throughout a day may involve altering temperature setpoints in the morning, afternoon, and night.

Regulation of the controlled conditions may refer to a process of monitoring and adjusting various physical conditions, such as the lighting, temperature, air quality, humidity, and other factors that contribute to controlled conditions of a building, such as the building 102. This regulation is usually done to respond to changes in external environmental conditions, occupancy patterns, and specific requirements of the use of the building 102. For example, the external environmental conditions, such as changes in weather, may influence the controlled conditions of the building 102 requiring adjustments to the operating parameters of the asset 104-1 of the building 102. Additionally, the use of the building 102 may change over time, for example, an office building generally becomes vacant after business hours, prompting a shift in the desired controlled conditions to conserve energy while still preventing environmental extremes that may damage the asset 104-1 of the building 102. In the case of a warehouse, type of produce stored may dictate different temperature and humidity levels, which can change with the inventory.

To address these dynamic requirements, controllers that regulate the controlled conditions within the building 102 are used. In an example, a local controller 106 may be implemented to regulate the controlled conditions of the building 102, for example, by controlling the operation of the asset 104-1 to ensure the maintenance of desirable controlled conditions within the building 102, safety of the asset 104-1, and also sustainable operation of the building 102. For example, the local controller 106 can be used to control the HVAC system to control temperature of different zones (e.g., rooms, areas, spaces, and/or floors) of the building 102. The local controller 106 may set and/or adjust setpoints for the various operating parameters of the HVAC system, such as supply water, temperature, and/or air speed, among others, depending on the conditions of the building 102.

The local controller 106 may be any computing device, such as a server, a desktop computer, a laptop, a smartphone, or a tablet. The local controller 106 may comprise one or more processors for executing instructions to control and monitor the operating parameters of the asset 104-1. In an example, the processor may be implemented as microprocessors, microcomputers, microcontrollers, digital signal processors, central processing units, state machines, logic circuitries, and/or any devices that manipulate signals based on operational instructions. The local controller 106 may comprise a memory for storing the instructions executable by the one or more processors. The instructions may cause the processor to control and monitor the operating parameters of the asset 104-1. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

In an example, to achieve predefined controlled conditions within the building 102, the operating parameters corresponding to the asset 104-1 may be controlled by the local controller 106. The local controller 106 may regulate the operation of the asset 104-1 by controlling the operating parameters of the asset 104-1 in accordance with setpoints that may be defined for the operating parameters of the respective asset 104-1 to achieve the predefined controlled conditions. In an example, a predefined controlled condition may correspond to a certain level of humidity in the building 102. This specific level of humidity may be understood as a setpoint, which is a target value for the controlled condition. To achieve said humidity level, the local controller 106 may regulate the operation of one or more assets, such as the HVAC system by controlling the operating parameters, such as an air flow rate and water flow rate of the HVAC system. For instance, if the desired humidity level is 45% relative humidity, the local controller 106 may adjust the air flow rate and water flow rate of the HVAC system to increase or decrease moisture in the air, thereby achieving the desired humidity level of 45% relative humidity which is the predefined controlled condition to be achieved within the building 102.

The operating parameters of an asset may be understood as measurable attributes of the asset that may be controlled to control an output of the asset. Examples of the operating parameters, for example, of the HVAC system, may include the supply water, the air temperature, and/or the air speed, among others, associated with various components of the HVAC system, that may be sensed, for example, by a corresponding sensor. Accordingly, one or more sensors 108-1, 108-2 . . . , and 108-n (hereinafter sensor 108-1) may be connected with the corresponding assets 104-1, 104-2, . . . and 104-n to sense the operating parameters associated with the corresponding assets 104-1, 104-2 . . . , and 104-n. The local controller 106 may use the data from the sensor 108-1, which represents a value of the corresponding operating parameters to monitor the operations of the asset 104-1. Referring to the previous example, to achieve a predefined level of humidity within the building 102, the operating parameters, such as the airflow rate and water flow rate may be monitored using the sensor 108-1 connected with the asset 104-1 to sense the operating parameters associated with the corresponding asset 104-1, 104-2 . . . , and 104-n. The local controller 106 may use the data from the sensor 108-1, which represents a value of the corresponding operating parameters, to monitor and adjust the operations of the HVAC system to achieve the predefined level of humidity.

In some cases, the building 102 may be divided into a plurality of zones and there may be a separate local controller 106 for each zone of the building 102. A zone within the building 102 may refer to a specific area or section of the building 102 where the controlled conditions can be maintained. For example, the zone may be a single room, a group of rooms, or an area within the building 102 that may have an asset, such as the asset 104-1, operable to achieve the predefined controlled conditions in said zone. Each zone may have different occupancy patterns, thermal characteristics, or usage purposes, necessitating individualized control of the physical conditions such as the temperature, humidity, and air quality. A supervisory controller (not illustrated) that can provide instructions to the local controller 106 of a zone corresponding to the setpoints for the operating parameters of the asset 104-1 that control the controlled conditions in the zone.

In accordance with example implementations of the present subject matter, the local controller 106 works in conjunction with a building operations optimizer 112 (hereinafter optimizer 112) to achieve the predefined the controlled conditions. As explained previously, the optimizer 112 is a system that is configured to determine suitable setpoints for various operating parameters of the assets of the building 102 for achieving the predefined desired controlled conditions. The optimizer 112, in an example, may use tools, such as artificial intelligence based algorithms and data analytics to determine setpoints corresponding to each of the desired controlled conditions, which may often vary significantly.

The optimizer 112, as explained previously, is to take into account variables that may affect the controlled conditions of the building 102. These variables may include but are not limited to, actual occupancy levels, and weather conditions, which may impact the internal conditions of the building 102. By considering such variables, the optimizer 112 may dynamically adjust the setpoints for the operating parameters of the asset 104-1.

In one example, the adjustments in the setpoints that are determined by the optimizer 112 are communicated via a network 114 to the local controller 106, which, in turn, operates actuators 110-1, 110-2, . . . , and 110-n (hereinafter actuator 110-1) to modify settings of the corresponding assets 104-1, 104-2, . . . , and 104-n so that the operation of the assets 104-1, 104-2, . . . , and 104-n reflects the adjusted setpoints.

In an example, a “setpoint” of an operating parameter of an asset, such as the asset 104-1, may be either a value (single value) or it may be a pair of values corresponding to minimum and maximum bound. For example, a setpoint for an operating parameter, i.e., temperature settings, can be defined as 25° C. or as 20° C. and 30° C. The setpoint can also be a range of values comprising values ranging from a minimum to a maximum value. For example, the setpoint for the temperature settings may be defined as 20° C. to 30° C. The setpoints for the operating parameter of the asset 104-1 may be prescribed depending on the configuration of the optimizer 112 and the asset 104-1. For instance, in cases where the optimizer 112 defines a single value of the setpoint, such as 25° C., the asset 104-1 may use the defined single value setpoint or compute a range of setpoints based on the defined single value of the set point. For example, the asset may compute 20° C. to 30° C. as the setpoint values considering the single value as the mean value.

In an example, the network 114 may be a single network or a combination of multiple networks and may use a variety of different communication protocols. The network may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 114 includes various network entities, such as gateways, routers; however, such details have been omitted for the sake of brevity of the present description.

In an example, the optimizer 112 may be implemented on a server or other computing device (not illustrated) that communicatively couples to the local controller 106, for example, via the network 114. The server running the optimizer 112 may be a standalone server or maybe a remote server on a cloud computing platform to which the local controller 106 may be connected over the network 114 directly or through the supervisory controller. In an embodiment, the server may be a cloud-based computing system. The server may include one or more servers on which an operating system may be installed that may run the optimizer 112. The server may comprise one or more processing units, one or more storage devices, such as memory units, for storing data and machine-readable instructions for example, applications and application programming interfaces (APIs), and other peripherals required for providing cloud computing functionality.

In accordance with example embodiments of the present subject matter, the network environment 100 includes a system 116 configured to avoid implementation of setpoints that are unsafe for the asset 104-1, for instance, in scenarios where the optimizer 112 may define such setpoints for the asset 104-1 owing to a malfunction in the optimizer 112 or due to incorrect sensor readings of physical conditions in the building 102 made available to the optimizer 112 due to a faulty sensor. The system 116 is also operable to handle data losses stemming from sensing and/or communication problems.

Examples of the system 116 may be a computing device, such as a server, a single or a distributed computing device. In an example embodiment, the computing device, such as a server running the optimizer 112 may also host the system 116. In an alternative embodiment, the system 116 may be hosted on a separate cloud server or the like.

In operation, the system 116 determines a first range of setpoints, a second range of setpoints, and a third range of setpoints for each of the assets 104-1, 104-2, . . . , and 104-n installed in the building 102. These ranges of setpoints may be predefined corresponding to each of the assets 104-1, 104-2, . . . , and 104-n installed in the building 102, for example, based on the design and capacity of the respective assets 104-1, 104-2, . . . , and 104-n.

The first range of setpoints corresponds to values of the operating parameters of the asset 104-1 in accordance with a predefined optimal operating conditions for the asset 104-1. The second range of setpoints corresponds to values of operating parameters of the asset 104-1 in accordance with a predefined sub-optimal operating conditions for the asset 104-1. The third range of setpoints corresponds to values of the operating parameters of the asset 104-1 in accordance with a predefined unsafe operating conditions for the asset 104-1.

According to an example implementation of the present subject matter, the predefined optimal operating conditions correspond to conditions under which the asset 104-1 operates safely. For example, in the building 102, the optimal operating conditions for an asset, such as the asset 104-1, may refer to conditions under which the asset 104-1 operates at its peak efficiency and effectiveness as determined by predefined factors, such as the rated capacity relating to the performance capability of the asset 104-1 to prevent malfunctions or damage to the asset 104-1 during its installation and operation in the building 102. The rated capacity of the asset 104-1 may be defined by the manufacturer of the asset 104-1 and is based on a variety of factors including design of the asset 104-1. For example, the rated capacity of the HVAC system may define a range of temperatures, airflow rates, and humidity levels at which the HVAC can function efficiently without undue stress on its components, thereby ensuring the longevity and safety of the HVAC system. The specifications from the manufacturer may include the range of values of the operating parameters that the asset 104-1 can handle based on the rated capacity of the asset 104-1, which in turn may inform what is considered to be the ‘optimal operating conditions’ of the asset 104-1. For example, the rated capacity for an air conditioning (AC) unit may specify that the AC unit can efficiently cool an area when operating within a temperature range of 18-30° C. Similarly, a motor with a specific rating may be designed to pump fluid at an optimum rate of 10 liters per minute.

If the asset 104-1 is operated in accordance with its optimal operating conditions, the asset 104-1 provides its optimal output. In other words, during its operation to achieve a predefined controlled condition the building 102, if the setpoints that the asset 104-1 is operated to achieve, are in accordance with the optimal operating conditions, the optimal output of the asset 104-1 is ensured. These setpoints that correspond to the optimal operating conditions refer to the first range of setpoints. Evidently, the first range of setpoints are values of the operating parameters of the asset 104-1 that aim to allow the asset 104-1 to operate in accordance with the rated capacity of the asset 104-1. For example, when actual measured values of the operating parameters of the HVAC system, such as current temperature, airflow rate, and humidity levels correspond to the rated capacity, the HVAC system is considered to be functioning under the optimal operating conditions.

In accordance with an example implementation of the present subject matter, the asset 104-1 may be considered to be operating within the sub-optimal operating conditions when the operating parameters of the asset 104-1 do not correspond to the rated capacity for the optimal operating conditions. In other words, the sub-optimal operating conditions are characterized by the setpoints for the operating parameters of the asset 104-1 that are not within the first range of setpoints but still within a range that does not compromise the safety of the asset 104-1. For example, for an asset, the sub-optimal operating conditions may arise when the setpoints for the operating parameters of the asset do not comply with prespecified ranges of setpoints, i.e., the first range of setpoints, corresponding to the optimal operating conditions. When the operating parameters fall outside of the prespecified ranges, for example, the first range of setpoint, but remain within ranges that do not endanger the safety of the asset 104-1, the asset 104-1 is considered to be functioning under the sub-optimal operating conditions. Such a range of values for the setpoints is referred to as the second range of setpoints.

In accordance with an example implementation of the present subject matter, the unsafe operating conditions may refer to scenarios where the operating parameters of the asset 104-1 go even beyond the sub-optimal operating conditions exceeding predefined safety thresholds, leading to risk to the safety of the asset 104-1. The unsafe operating conditions are characterized by the setpoints of the operating parameters of the asset 104-1 that fall outside of the predefined safety thresholds, which are prescribed to prevent damage to the asset 104-1. In an example, the safety thresholds may be defined by the manufacturer based on the rated capacity of the asset 104-1. The first range of setpoints, the second range of setpoints, and the third range of setpoints, for an asset, such as the asset 104-1 may be defined by an engineer designing the BMS or personnel managing building operations based on the predefined safety thresholds.

To ensure that the asset 104-1 is operating within the first range of setpoints identified to be optimal for the asset 104-1, the system 116 monitors the current setpoints of the asset 104-1. Such a monitoring allows for the current setpoint to be altered in cases where the current setpoints are not in accordance with the first range of setpoints, so as to optimize the operation of the asset 104-1.

The current setpoints are provided by the optimizer 112 based on inputs from sensors, such as the sensor 108-1, installed in the building 102 to sense the operating parameter of the asset 104-1 as well as the physical conditions pertaining to occupancy and weather conditions in the building 102. For example, the current setpoints for the asset 104-1 are provided by the optimizer 112 over the network 114 to the local controller 106 that operates the asset 104-1 to comply with the current setpoints provided by the optimizer 112.

In an example, the process of monitoring the operation of the asset 104-1 may involve the system 116 actively receiving real-time or near real-time site data. The site data may be indicative of a current operational status of the asset 104-1 and includes data corresponding to the setpoints of the operating parameters of the asset 104-1 as set by the optimizer 112. The site data is collected by the local controller 106 based on input from the sensor 108-1. The local controller 106 serves as an intermediary between the sensor 108-1 and the system 116. The local controller 106 collects the data corresponding to the current setpoints of the asset 104-1 from the sensor 108-1 and then transmits this data over the network 114 to the system 116. In an alternative embodiment of the present subject matter, the site data can be sent directly to the system 116 by the sensor.

Once the system 116 receives the data pertaining to the current setpoints for the asset 104-1, the system 116 proceeds to compare the current setpoints against the prespecified range of setpoints, i.e., the first range of setpoints, defined for the optimal operating conditions of the asset 104-1. If the system 116 ascertains that the current setpoints, as defined by the optimizer 112 for the asset 104-1, lie outside of the first range of setpoints, which corresponds to the values of the operating parameters of the asset 104-1 in accordance with the predefined optimal operating conditions for the asset 104-1, the system 116 may apply corrective actions.

In accordance with an example implementation of the present subject matter, a corrective action may include issuing commands to the local controller 106 to adjust the current setpoints of the asset 104-1 to bring the setpoints of the asset 104-1 within the first range of the setpoints. In another example, the corrective action may include notifying a building operations manager of the building 102 to intervene and take the requisite actions.

Thus, by using the site data corresponding to the ongoing operation of the asset 104-1, the system 116 may adjust or override any unsuitable setpoints that may result from faulty readings due to sensing or communication issues with the optimizer 112. Therefore, based on the latest site data, the system 116 can provide a safe range of setpoints to the local controller 106, which can then configure the operating parameters of the asset 104-1 within these safe ranges of setpoints.

By bringing the setpoints of the asset 104-1 within the safe range of setpoints, i.e., the first range of setpoints, potential damage to the asset 104-1 may be prevented.

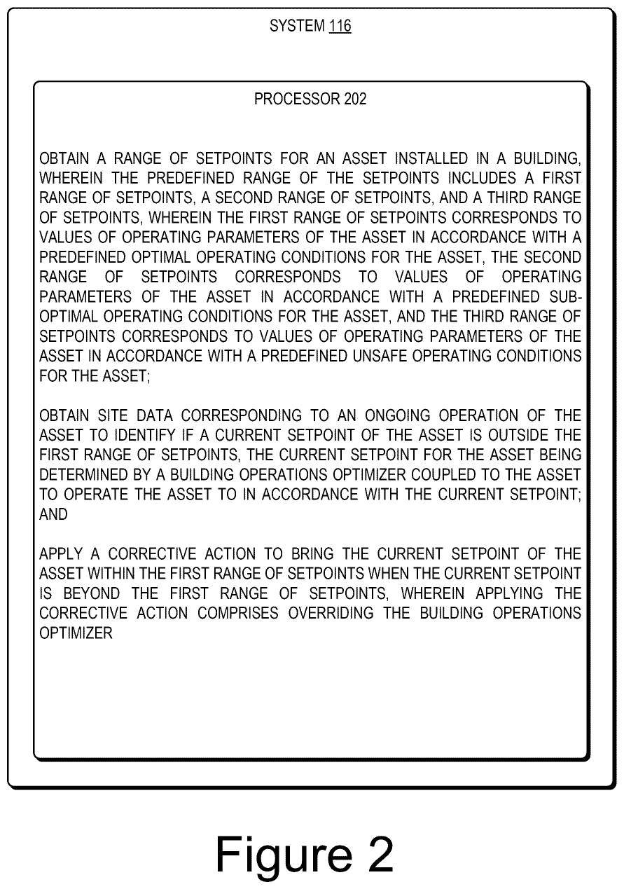

FIG. 2 shows the system 116 that may be implemented to account for the safe operation of the asset 104-1 in the building 102, according to an example implementation of the present subject matter.

In an example, the system 116 may be a computing device comprising a processor 202. In an example, the processor 202 may be implemented as microprocessors, microcomputers, microcontrollers, digital signal processors, central processing units, state machines, logic circuitries, and/or any devices that manipulate signals based on operational instructions. The processor 202 may execute instructions stored in a memory of the system 116 to accomplish functionalities of the system 116.

As explained previously, the optimizer 112 that is responsible for determining the setpoints for the operating parameters of the asset 104-1 may recommend unsuitable setpoints due to incorrect sensing of the current controlled conditions of the building or due to algorithm failure, risking damage to the asset 104-1 or causing discomfort to the occupants. As also discussed previously, the optimizer 112 may lack mechanisms to handle data losses due to communication issues, resulting in the determination of unsafe setpoints for the asset 104-1.

The system 116 checks the setpoints adjustments provided by the optimizer 112 and keeps the setpoints adjustments within the safe range of setpoints, for example, the first range of setpoints. Thus, the system 116 may provide for usage of the asset 104-1 in accordance with conditions prescribed for efficient operation of the asset 104-1 throughout their service life. The system 116 provides for prolonging useful life of the asset 104-1 without additional maintenance to be performed on them.

In an example embodiment of the present subject matter, the processor 202 of the system 116 determines prespecified range of setpoints for the asset 104-1 installed in the building 102. The prespecified range of setpoints includes the first range of setpoints, the second range of setpoints, and the third range of setpoints. The first range of setpoints corresponds to values of the operating parameters of the asset 104-1 in accordance with the predefined optimal operating conditions for the asset 104-1. The second range of setpoints corresponds to values of the operating parameters of the asset 104-1 in accordance with the predefined sub-optimal operating conditions for the asset 104-1. The third range of setpoints corresponds to values of the operating parameters of the asset 104-1 in accordance with the predefined unsafe operating conditions for the asset.

In an example, the prespecified range of setpoints for each of the assets 104-1, 104-2, . . . , and 104-n within the building 102 may be preconfigured in the system 116. In one example, the prespecified range of setpoints may be defined based on design type and the rated capacity of the asset 104-1. For example, based on the design type and the rated capacity, the first, second, and third range of setpoints that would, in operation of the asset 104-1, correspond to the aforesaid optimal, sub-optimal, and unsafe operating conditions may be determined.

In another example, the prespecified range of setpoints may be determined by the system 116 based on historical data relating to the operation of the asset 104-1. For example, an asset, such as the asset 104-1, may have been operated over a period of time in a manner that the performance of the asset 104-1 has been found to be optimal. For instance, the output of the asset 104-1 may have been in accordance with the rated capacity of the asset 104-1 over a period of time without any malfunctioning or without excessive fuel consumption, etc. Such conditions under which the asset 104-1 has been operated historically may be determined by the system 116 to be the optimal operating conditions for the asset 104-1. The range of setpoints associated with the optimal operating conditions may be determined to be the first range of setpoints. The second and third range of setpoints may be computed based on the determined first range of setpoints, for example, by considering values that exceed the determined first range of setpoints.

In yet another example, the prespecified range of setpoints for the asset 104-1 may be determined by a user. For example, the user may be a building operations manager of the building 102 who may be aware of the safe operating conditions of the asset 104-1 and may define the first, second, and third range of setpoints based on his knowledge. Similarly, a user such as an occupant of the building 102 may also define setpoint ranges, for example, based on his requirement.

To ensure that the setpoints of the operating parameters of the asset 104-1 are within the safe range of setpoints, the system 116 obtains the site data corresponding to an ongoing operation of the asset 104-1 to identify if the current setpoint of the asset 104-1 is outside the first range of setpoints. In an example, the site data may be indicative of a controlled condition that has been set by the optimizer 112 to be achieved in the building 102.

As explained previously, the current setpoint for the asset 104-1 is defined by the optimizer 112 to operate the asset 104-1 in accordance with the current setpoint. In an example, the system 116 may obtain data corresponding to the current setpoint as defined by the optimizer 112 by communicating with the local controller 106. In an alternative embodiment, the system 116 may communicate with the optimizer 112 to obtain data corresponding to the current setpoint.

Further, based on the site data, if the processor 202 identifies that the current setpoint of the asset 104-1 is set beyond the first range of setpoints by the optimizer 112, the processor 202 applies the corrective action. In an example, the corrective action may comprise overriding the optimizer 112 to provide the safe range of setpoints to the local controller 106. The local controller 106 may, in one example, adjust the current setpoint of the asset 104-1 to bring the values of the operating parameters of the asset 104-1 within the safe range of setpoints provided by the processor 202. As will be understood based on the foregoing explanation, the safe range of setpoints provided by the processor 202 corresponds to the predefined optimal operating conditions for the asset 104-1, i.e., the first range of setpoints.

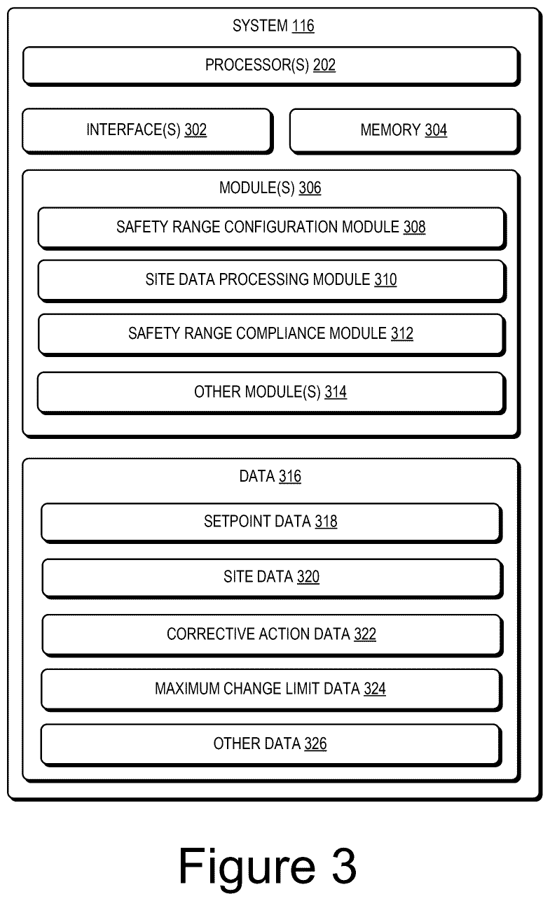

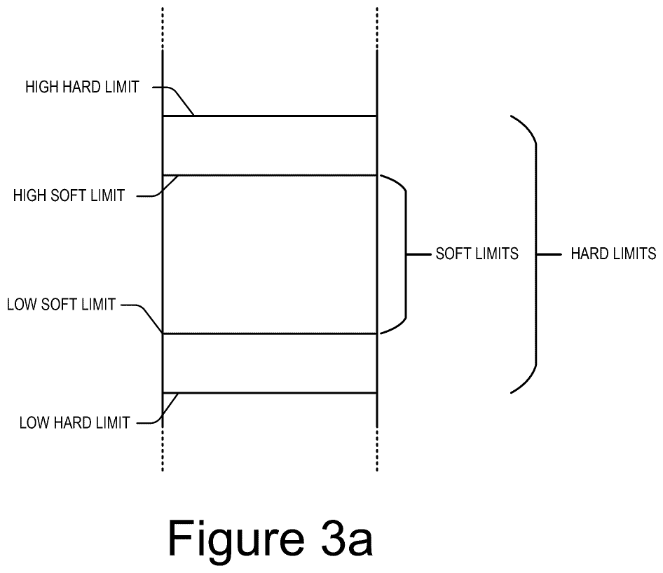

To elaborate on the functioning of the system 116 to provide the safe range of setpoints to the local controller 106 to control the setpoints of the operating parameters of the asset 104-1 within the safe range of setpoints, reference is made to FIG. 3.

FIG. 3 illustrates the system 116 configured to provide the safe range of setpoints, i.e., the first range of setpoints, to prevent the undesired occupant discomfort or potential damage to the asset 104-1, according to another example implementation of the present subject matter. FIG. 3a schematically illustrates categorization of the prespecified range of setpoints described in reference to FIGS. 1-2 in a set of limits, in accordance with another example implementation of the present subject matter. Therefore, FIG. 3 and FIG. 3a are herein described together for clarity.

In accordance with an example implementation of the present subject matter, the system 116 is operable to account for the optimal operation of the asset 104-1 even in situations where building operations optimizers, such as the optimizer 112, propose the setpoints that may lead to potential harm to the asset 104-1, or cause discomfort to the occupants of the building 102. As explained above, such situations may arise due to sensor malfunctions and/or communication breakdowns, or malfunctioning of the optimizer 112.

In an example, the system 116 depicted in FIG. 3 may be any computing device. Examples of the system 110 include but are not restricted to servers, desktop computers, laptops, smartphones, personal digital assistants (PDAs), and tablets.

In an example implementation, the system 116 comprises the processor 202. The system 116 also comprises interface(s) 302 coupled to the processor 202. The interface(s) 302 may include a variety of software and hardware interfaces that allow interaction of the system 116 with other communication and computing devices, such as network entities, web servers, external repositories, and peripheral devices. For example, the interface(s) may couple the system 116 with the optimizer 112. The interface(s) 302 may also enable coupling of internal components, if any, of the system 116 with each other.

Further, the system 116 comprises a memory 304 coupled to the processor 202. The memory 304 may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like. The system 116 may comprise module(s) 306 and data 316 coupled to the processor 202. In one example, the module(s) 306 and data 316 may reside in the memory 304.

In an example, the data 316 may comprise setpoint data 318, site data 320, corrective action data 322, maximum change limit data 324, and other data 326. The module(s) 306 may include routines, programs, objects, components, data structures, and the like, which perform particular tasks or implement particular abstract data types. The module(s) 306 further includes modules that supplement applications on the system 116, for example, modules of an operating system. The data 316 serves, amongst other things, as a repository for storing data that may be fetched, processed, received, or generated by one or more of the module(s) 306. The module(s) 306 may include a safety range configuration module 308, a site data processing module 310, a safety range compliance module 312, and other module(s) 314. The other module(s) 314 may include programs or coded instructions that supplement applications and functions, for example, programs in the operating system of the system 116.

In an example implementation of the present subject matter, the safety range configuration module 308 may be utilized to preconfigure the system 116 with the prespecified range of setpoints, i.e., the first range of setpoints, the second range of setpoints, and the third range of setpoints, for the operating parameters of the asset 104-1 installed in the building 102.

This preparatory configuration may be performed in advance of executing the functionalities of the system 116, in one example implementation. Dataset generated by the pre-configuration of the prespecified range of setpoints may be stored in the data 316 of the system 116 as the setpoint data 318. As explained previously, the prespecified range of setpoints for the operating parameters of the asset 104-1 may be preconfigured in the system 116 based on various considerations, such as the design type and the rated capacity of the asset 104-1, and the historical data relating to the operation of the asset 104-1, for example.

Preconfiguring the system 116 with the prespecified range of setpoints ensures that the system 116 has a reference in terms of baseline values of the setpoints for comparison. When the optimizer 112 determines the setpoints for the operating parameters of the asset 104-1 in accordance with the desired controlled conditions, the system 116 can reference the prespecified ranges of setpoints to determine if the setpoints determined by the optimizer 112 are appropriate for maintaining safe operations of the asset 104-1 in light of actual controlled conditions within the building 102.

In operation, due to the sensing or communication error, the real-time data corresponding to the operating parameters of the asset 104-1, occupancy of the building 102, and prevailing weather conditions made available to the optimizer 112 may be inaccurate. Consequently, the optimizer 112 may erroneously suggest a temperature setpoint for the HVAC system that is much lower than what is actually comfortable for the occupants of the building 102, based on an inaccurate sensor. The system 116, preconfigured with the prespecified range of setpoints for the HVAC system, may assess the temperature setpoint proposed by the optimizer 112 and upon comparison, detect that the suggested setpoint is outside the first range of setpoints that is established as the safe range of setpoints, indicating a potential error.

In an example implementation of the present subject matter, the safety range configuration module 308 may be utilized to define the minimum and the maximum bound of the setpoints of the operating parameters of the asset 104-1. The maximum bound may be defined by the safety range configuration module 308 as an upper limit of the setpoint for an operating parameter of the asset 104-1, beyond which the system 116 may not allow the asset 104-1 to operate to ensure the safe operation of the asset 104-1. Conversely, the safety range configuration module 308, may define the minimum bound as a lower limit of the setpoint of the operating parameter of the asset 104-1 below which the system 116 may not allow the asset 104-1 to operate. This is the minimum value that the setpoint can be adjusted to. Should the optimizer 112 propose a setpoint for the operating parameter of the asset 104-1 above the maximum bound or below the minimum bound, the system 116 may intervene to prevent the setpoint from going above the maximum bound or below the minimum bound, respectively. For example, if the safety range configuration module 308 has set a minimum bound of 68° F. and a maximum bound of 74° F. for the temperature setpoints of the HVAC system, and if the optimizer 112 suggests a setpoint of 76° F., which is above the maximum bound, the system 116 may intervene to bring the setpoint from 76° F. to 68° F.-74° F. range, for instance, by resetting the setpoint provided by the optimizer 112 to the local controller 106. Similarly, if a setpoint of 66° F. is proposed by the optimizer 112, which is below the minimum bound, the system 116 may intervene to bring the setpoint from 66° F. to 68° F.-74° F. range.

In an example implementation of the present subject matter, the range of setpoints specified by the safety range configuration module 308, which includes the first range of setpoints, the second range of setpoints, and the third range of setpoints, may be categorized in the set of limits, as shown in FIG. 3a. The set of limits may include a high soft limit, a low soft limit, a high hard limit, and a low hard limit. Herein, the high soft limit and the low soft limit are collectively called soft limits. Similarly, the high hard limit and the low hard limit are collectively called hard limits.

In an example, the safety range configuration module 308 may be configured to define the high soft limit as a maximum value of the setpoint for an operating parameter of the asset 104-1 that may be set without impacting the optimal operating condition of the asset 104-1. Similarly, the safety range configuration module 308 may be configured to define the low soft limit as a minimum value of the setpoint for the operating parameter of the asset 104-1 that may be set without impacting the optimal operating condition of the asset 104-1. For example, in the HVAC system, the high soft limit may be set at 24° C., which is the maximum temperature setpoint that the optimizer 112 may be allowed to set to achieve the optimal operating condition for the HVAC system. Similarly, the low soft limit for the HVAC system may be set at 20° C., which is the minimum temperature setpoint that the optimizer 112 may be allowed to set to allow the operation of the HVAC system under the optimal operating conditions. Accordingly, the first range of setpoints may correspond to values of the setpoints for the operating parameters of the asset 104-1 that lie between the high soft limit and the low soft limit.

In another example, the safety range configuration module 308 may be configured to define the high hard limit as an uppermost value of the setpoint of the operating parameter of the asset 104-1 that the system 116 may not allow to exceed when setting the setpoints for the operating parameter of the asset 104-1. The high hard limit corresponds to the maximum bound of the setpoints of the operating parameters of the asset 104-1. The low hard limit may be defined as a lowermost value of the setpoint of the operating parameter of the asset 104-1 that the system 116 may not allow to be breached when setting the setpoints for the operating parameter of the asset 104-1. The low hard limit corresponds to the minimum bound of the setpoints of the operating parameters of the asset 104-1.

In an example, when the setpoints for the operating parameters of the asset 104-1 are set between the high soft limit and the high hard limit or between the low soft limit and the low hard limit, the asset 104-1 may be considered to be operating under the sub-optimal operating conditions. This means that while the setpoints are within the range that does not compromise the safety of the asset 104-1, the setpoints are not within the first range of setpoints that is an ideal range for the optimal operating conditions for the asset 104-1 as defined by the high soft limit and the low soft limit. For example, to operate the HVAC system under the optimal operating conditions, the high soft limit may be set at 23° C., and the low soft limit may be set at 21° C., for instance, by the manufacturer of the HVAC system. However, to prevent freezing pipes or overheating equipment, the HVAC system may have a high hard limit set at 26° C. and a low hard limit set at 16° C. If an optimizer of the HVAC system, such as the optimizer 112, sets the temperature setpoint at 24° C., this is above the high soft limit but below the high hard limit. Similarly, if the setpoint is set at 20° C., this is below the low soft limit but above the low hard limit. In both cases, the HVAC system may operate within the predefined safety thresholds, i.e., between the high hard limit and the low hard limit, but outside the soft limits. Therefore, the HVAC system may be considered to be operating under the sub-optimal operating conditions, as the HVAC system may not be operating under the optimal operating conditions, even though the HVAC system is operating within the predefined safety thresholds.

In yet another example, the safety range configuration module 308 may be configured to identify the values of the setpoint for the operating parameter of the asset 104-1 that exceed the high hard limit or fall below the low hard limit as falling within the third range of setpoints. For example, in the HVAC system, the high hard limit for the temperature setpoint may be established at 26° C. to prevent the HVAC system from overheating a space in the building 102, which may lead to increased energy costs and discomfort for the occupants. Conversely, the low hard limit may be set at 18° C. to prevent the HVAC system from undercooling and causing safety issues for the HVAC system, such as frozen pipes. For instance, owing to incorrect temperature information made available to the optimizer 112, the optimizer 112 may set the temperature setpoint to 27° C. However, this value exceeds the high hard limit. Similarly, a malfunction may cause the optimizer 112 to set the temperature setpoint to 17° C., but this falls below the low hard limit. In both cases, the values of the setpoint proposed by the optimizer 112 exceed the predefined high hard limit and low hard limit that may correspond to the unsafe operating conditions for the HVAC system. In an example, if the setpoints were to remain at these levels, i.e., at 27° C. or 17° C., leading to prolonged operation of the HVAC system outside of the predefined safety thresholds, it may result in damage to the HVAC system. For example, continuous operation at a temperature above the high hard limit may strain the cooling system, potentially leading to mechanical failure or reduced lifespan of the cooling system of the HVAC system. Similarly, operation below the low hard limit may increase the risk of condensation and freezing within the HVAC system, which may cause pipe bursts or other damage. Therefore, the system 116 is configured to intervene and adjust the setpoints to prevent such occurrences and maintain the operation of the asset 114-1 within the predefined safety thresholds.

According to an example implementation of the present subject matter, the hard limits and the soft limits may be dynamic rather than static, meaning they may change over a period of time or based on specific conditions. For example, the hard limits and the soft limits may vary at different times of a day to accommodate varying operational demands. For example, energy demand may be higher in the morning as the building 102 heats up, requiring different setpoint limits than in the afternoon when the building 102 may have reached a stable temperature. Similarly, the hard limits and the soft limits may be adjusted in accordance with day and night conditions by the safety range configuration module 308. For example, during the night, when the building 102 may be unoccupied, the system 116 may allow for wider temperature setpoint ranges, reflected in different hard and soft limits. In another example, the hard limits and the soft limits may also be adjusted by the safety range configuration module 308 based on calculations performed either by the local controller or by the system 116. These calculations may take into account the historical data relating to the operation of the asset 104-1, predictive models, or real-time analytics to optimize the setpoint limits for specific periods.

In yet another example embodiment of the present subject matter, the hard limits and the soft limits may also be adjusted by the safety range configuration module 308 based on at least one of an ambient temperature, ambient humidity, occupancy level of the building 102, and fuel prices. For example, if outside temperature is extremely cold, the system 116 may set a higher low soft limit to ensure that the building 102 remains adequately heated. Similarly, in areas of the building 102 with high humidity, the system 116 may adjust the limits to ensure that dehumidification processes maintain the occupant comfort without overburdening the HVAC system. Likewise, the system 116 may change the limits based on the occupancy in the building 102. A higher occupancy level may require tighter control of the controlled conditions, leading to different setpoint limits. Similarly, economic factors such as the price of fuel can also influence the limits. For example, if the fuel prices are high, the system 116 may adjust the limits to conserve energy and reduce operational costs.

In an example, while the hard limits and the soft limits may be defined to be variable over the period of time and dependent on certain parameters in the safety range configuration module 308, the hard limits and the soft limits may not be varied to exceed the predefined maximum bound or fall below the minimum bound at any time to ensure the safety of the asset 104-1.

According to example implementations of the present invention, the site data processing module 310 may be configured to obtain the current setpoints provided by the optimizer 112 for the asset 104-1 to determine if the setpoints provided by the optimizer 112 for the asset 104-1 corresponds to the first range of setpoints. The site data processing module 310 may determine the current setpoints based on the site data. The site data processing module 310 may communicate with the local controller 106 to receive the site data. The site data is collected by the local controller 106 based on the input from the sensors 108-1, 108-2, . . . , and 108-n. The local controller 106 collects the data corresponding to the current setpoints of the asset 104-1 from the sensors 108-1, 108-2, . . . , and 108-n, and then transmits this data to the site data processing module 310. The site data processing module 310 may store the data corresponding to the current setpoints of the asset 104-1 in the memory 304 as the site data 320 for further processing.

After having received the data pertaining to the current setpoints for the asset 104-1, the site data processing module 310 proceeds to compare the current setpoints against the prespecified range of setpoints defined for the optimal operating conditions of the asset 104-1. If the site data processing module 310 ascertains that the current setpoints, as defined by the optimizer 112 for the asset 104-1, lie outside of the first range of setpoints, which corresponds to the values of the operating parameters of the asset 104-1 in accordance with the predefined optimal operating conditions for the asset 104-1, the site data processing module 310 may cause the safety range compliance module 312 to apply the corrective actions.

In accordance with an example implementation of the present subject matter, the safety range compliance module 312 may issue commands to the local controller 106 to adjust the current setpoints of the asset 104-1 to bring the setpoints of the asset 104-1 within the first range of the setpoints. In an example, upon receiving the command from the safety range compliance module 312, the local controller 106 may operate independently of the optimizer 112 to adjust the current setpoints of the asset 104-1 to bring the setpoints of the asset 104-1 within the first range of the setpoints. In another example, the corrective action applied by the safety range compliance module 312 may include notifying the building operations manager of the building 102 to intervene and take the requisite actions to bring the setpoints of the asset 104-1 within the first range of the setpoints.

In accordance with an example implementation of the present subject matter, the safety range compliance module 312 may be configured to adjust the current setpoint in accordance with a maximum change limit that may be predefined in the safety range configuration module 308 for each of the assets 104-1, 104-2, . . . , and 104-n of the building 102. Data corresponding to the maximum change limit may be stored in the memory 304 of the system 116 as the maximum change limit data 324. The maximum change limit may be understood as a maximum allowable change to the setpoints of the operating parameters of the asset 104-1 within a given time frame. For instance, in the HVAC system, if the maximum change limit for the temperature setpoint is set to 2° C. per 10 min, and the current temperature setpoint is identified as 22° C., the safety range compliance module 312 may ensure that any adjustment to the temperature setpoint does not result in a temperature setpoint lower than 20° C. or higher than 24° C. within the next 10 min. Thus, complying with the maximum change limit prevents abrupt or drastic setpoint adjustments that may negatively impact the safety of the asset 104-2 or cause occupant discomfort.

In an example, the maximum change limit may be relative to the current setpoint of the operating parameter of the asset 104-1. For example, if the maximum change limit for the temperature setpoint is set to 2° C., and the current setpoint is measured to be 22° C., then any new setpoint set by the safety range compliance module 312 may not be lower than 20° C. or higher than 24° C. until next measurement cycle of the current setpoint. This ensures that the system 116 adjusts the temperature setpoint gradually, avoiding any sudden and large deviations from the current setpoint.

According to another example implementation of the present subject matter, the maximum change limit for the setpoint may be divided into maximum positive change limit and maximum negative change limit.

The maximum positive change limit may specify maximum amount by which the value of the setpoint of the asset 104-1 can be increased from its current value as obtained by the site data processing module 310. The maximum positive change limit defines an upper boundary for how much the current setpoint can be adjusted upwards during a given adjustment period. For example, in the HVAC system, if the maximum positive change limit is set to +3° C., and the current temperature setpoint obtained by the site data processing module 310 is 22° C., then the temperature setpoint cannot be set higher than 25° C. within the given time frame. Conversely, the maximum negative change limit specifies maximum amount by which the setpoint can be decreased from the current setpoint. The maximum negative change limit sets a lower boundary for how much the setpoint can be adjusted downwards. For example, if the maximum negative change limit is set to −3° C., and the current temperature setpoint obtained by the site data processing module 310 is 22° C., then the temperature setpoint in the HVAC system cannot be set lower than 19° C. within the given time frame.

Thus, by categorizing the maximum change limit into the positive and negative limits, the system 116 can have different thresholds for increasing and decreasing the setpoints of the asset 104-1, which may be useful in scenarios where the consequences of deviating from the safe range of setpoints are not symmetrical. This allows for more nuanced control of the asset 104-1, ensuring that setpoint adjustments are made within the safe range of setpoints, whether the asset 104-1 is heating up or cooling down the environment.

According to an example implementation of the present subject matter, based on the site data corresponding to the ongoing operation of the asset 104-1, if it is determined that the current setpoint of the asset 104-1 corresponds to the second range of setpoints, then the safety range compliance module 312 may adjust the current setpoint to bring the current setpoint within the first range of setpoints in accordance with a first rate of change. In another example, based on the site data corresponding to the ongoing operation of the asset 104-1, if it is determined that the current setpoint of the asset 104-1 corresponds to the third range of setpoints, then the safety range compliance module 312 may adjust the current setpoint to bring the current setpoint within the first range of setpoints in accordance with a second rate of change. Herein, the second rate of change may be higher than the first rate of change and lower than the maximum change limit.

For example, in the HVAC system, the first range of temperature setpoints may be set at 21-23° C. The second range of temperature setpoints may be set at 23-25° C. or 19-21° C. The third range of temperature setpoints may include temperatures above 25° C. or below 19° C. According to the present example, if the current temperature setpoint is determined to be within the second range, the safety range compliance module 312 may adjust the temperature setpoint back towards the first range at the first rate of change which may be a conservative rate of change. This is a slower adjustment in the temperature setpoint to gently guide the temperature setpoint back to the first range of temperature setpoints without causing abrupt changes that may be uncomfortable for the occupants or strain the HVAC system. If the current temperature setpoint is determined to be within the third range of setpoints, indicating a more urgent situation, the safety range compliance module 312 may adjust the setpoint back towards the first range of temperature setpoints at the second rate of change which may be a more aggressive rate of change. The second rate of change is faster than the first rate of change because the temperature is further from the first range of temperature setpoints and may require quicker intervention. However, the second rate of change is also controlled and does not exceed the maximum change limit, ensuring that the setpoint adjustments are safe and do not compromise the HVAC equipment or the comfort levels of the occupants within the building 102. For instance, if the current temperature setpoint of the HVAC system is 26° C., which falls into the third range of temperature setpoints, the safety range compliance module 312 may initiate a faster cooling process to reduce the temperature more quickly than if the setpoint were 24° C., which falls into the second range of temperature setpoints. Despite the increased rate of cooling, the adjustments in the temperature setpoints may be within the maximum change limit that is considered safe for the HVAC system to handle.

According to an example implementation of the present subject matter, data corresponding to the corrective action applied by the safety range compliance module 312 may be stored in the memory 304 as the corrective action data 322 for use as a reference in handling similar deviations in the current setpoints of the asset 104-1 against the prespecified range of setpoints defined for the optimal operating conditions of the asset 104-1. Additionally, the corrective action, whether automatically applied by the system 116 or recommended for manual application by a user, may be displayed in a control room of the building 102, for example, based on the zone of operation of the asset 104-1. This allows for real-time monitoring and intervention based on the zone of operation of the asset 104-1, facilitating prompt and informed decision-making to maintain the operation of the asset 104-1 within optimal operating conditions.

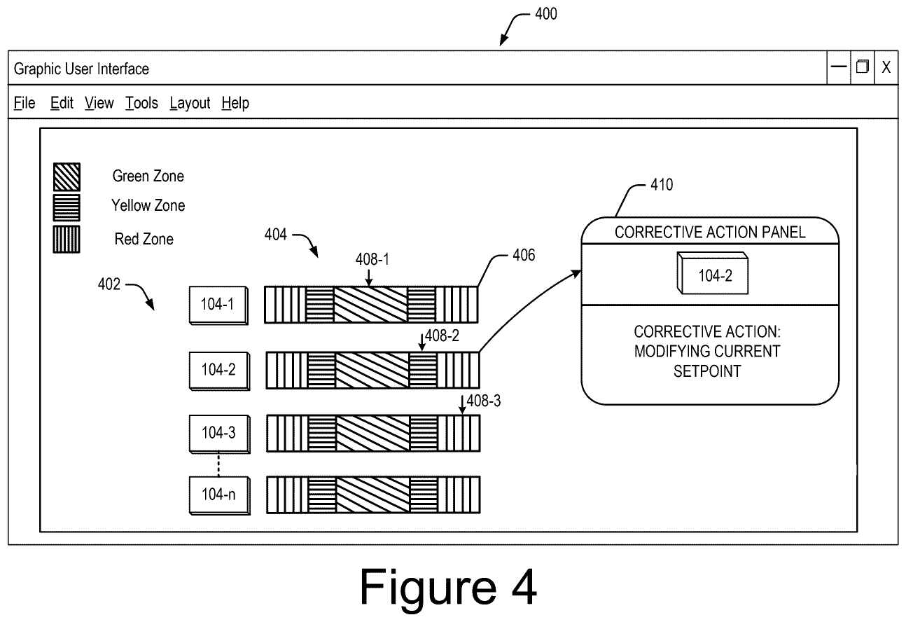

FIG. 4 illustrates an exemplary interface 400 for real-time display of a zone of operation of assets, such as the assets 104-1, 104-2, 104-3, . . . , and 104-n, of the building 102 to the user, for example, the building operations manager of the building 102, in the control room of the building 102, in accordance with an example implementation of the present invention. The embodiments of the interface 400 illustrated in FIG. 4 are for illustration only. FIG. 4 does not limit the scope of this disclosure to any particular implementation.

According to an example implementation of the present subject matter, the interface 400 may provide a list 402 of assets, such as the assets 104-1, 104-2, 104-3, . . . and 104-n, similar to the assets 104-1, 104-2, . . . , and 104-n described in reference to FIGS. 1-3, and a visual representation 404 of the zones of operation of the listed assets 104-1, 104-2, 104-3, . . . , and 104-n. The interface 400 provides a real-time understanding of the operation of the assets 104-1, 104-2, 104-3, . . . , and 104-n, for example, based on the determination of the current setpoint of the assets 104-1, 104-2, 104-3, . . . , and 104-n by the site data processing module 310.

In an example, the interface 400 may further provide the ability to adjust the setpoint of the assets 104-1, 104-2, 104-3 based on the determination of the zone of the operation of the assets 104-1, 104-2, 104-3 for example by allowing a user to provide manual inputs via the interface 400. The list 402 may be expanded (not shown) to allow the user to view details of the assets 104-1, 104-2, 104-3, . . . , and 104-n, such as an asset ID or location of the asset 104-1, 104-2, 104-3, . . . , and 104-n in the building 102, in one example.

As shown in FIG. 4, the visual representation 404 may include one or more charts, such as a bar chart 406. The visual representation 404 provides an easily discernable representation of the zone of operation of the assets 104-1, 104-2, 104-3, . . . , and 104-n. The visual representation 404 may be updated from time to time to indicate changes in the zone of operation of the assets 104-1, 104-2, 104-3, . . . , and 104-n. Where applicable, the visual representation 404 may also provide a mention of a corrective action corresponding to an asset. For example, if the setpoint defined by the optimizer 112 is modified for a particular asset, such as the asset 104-2, the modified value may be depicted in the visual representation 404. Alternatively, as depicted in FIG. 4, a dedicated panel for corrective actions, such as corrective action panel 410, may be displayed on the visual representation 404 when selecting the asset 104-2, showing the specific corrective action being implemented for that asset 104-2.

In accordance with an example implementation of the present subject matter, the operation of the assets 104-1, 104-2, 104-3 may be categorized into different zones based on the current setpoints of the assets 104-1, 104-2, 104-3 as determined by the site data processing module 310. For example, the current setpoints of the assets 104-1, 104-2, 104-3 may be categorized into either a green zone, yellow zone, or red zone. In an example, the green zone may be indicative of the operation of an asset, such as the asset 104-1, within the first range of setpoints. For example, referring to FIG. 4, if the current setpoint of the asset 104-1 is determined to be within the first range of setpoints, the visual representation 404 may get adjusted in real-time to indicate the operation of the asset in the green zone, for example, by placing an indicator 408-1 in the bar chart 406 that is indicative of the green zone. When the operating condition of the asset 104-1, is within the green zone, it implies that the asset 104-1 is operating within a target range, that is the first range of setpoints, that have been determined to be the optimum for the safety of the asset 104-1 and maintaining occupant comfort. In an example, the green zone is may be characterized by the setpoints of the operating parameters of the asset 104-1 that are between the high soft limit and the low soft limit.

In an example, even within the green zone, the system 116 may continue to check setpoints adjustments in the operating parameters of the asset 104-1 to ensure that the setpoints adjustments comply with the maximum positive and negative limits. The maximum positive and negative limits are complied with to prevent sudden, large changes in the setpoints that may damage the asset 104-1 or cause discomfort to the occupants. For example, if the maximum positive limit is 2° C. and the current setpoint is 20° C., the system 116 may ensure that any increase in the setpoint does not exceed 22° C. in the next adjustment. Similarly, if the maximum negative limit is −2° C., the system 116 may ensure that any decrease in the setpoint does not go below 18° C. By enforcing the maximum positive and negative limits, a stable and efficient operation of the asset 104-1 may be maintained with the green zone.

In another example, the yellow zone may be indicative of the operation of an asset, for example, the asset 104-2, between the second range of setpoints and the third range of setpoints. As will be understood, the yellow zone lies between the soft limits and the hard limits. The operation of the asset 104-2 in the yellow zone indicates that while the operation of the asset 104-2 may not be in the optimal operating conditions, the asset 104-2 is not in immediate danger or operating unsafely.

For example, referring to FIG. 4, if the current setpoint of the asset 104-2 is determined to be within the second range of setpoints, the visual representation 404 may get adjusted in the real-time to indicate the operation of the asset 104-2 in the yellow zone, for example, by placing an indicator 408-2 in the bar chart 406 that is indicative of the yellow zone. For example, for the HVAC system, the yellow zone might be from 18° C. to 20° C. and from 24° C. to 26° C. When the HVAC system operates within this range, it means the temperatures are slightly cooler or warmer than the ideal comfort level but not to an extent that may be considered unsafe for the HVAC system or severely uncomfortable for the occupants. Therefore, the yellow zone encompasses the setpoints that are outside the green zone but have not crossed into the red zone. The yellow zone serves as a buffer area where the asset 104-2 can still operate but with increased attention and caution to prevent moving into the red zone, which may be outside of the predefined safety thresholds.

In an example, when the asset 104-2 is operating in the yellow zone, the system 116 may suggest setpoint adjustments to bring the asset 104-2 back towards the green zone, minimizing the time spent outside the soft limits. The goal is to make incremental changes that may reduce the deviation from the first range of setpoint without causing discomfort or rapid changes that could damage the asset 104-2 or be disruptive to the occupant comfort. While making these setpoint adjustments, the system 116 also ensures that any change in the setpoint does not exceed predefined maximum positive and the maximum negative limits. For example, if the maximum limit change allowed is 1° C. at a time, even if the asset 104-2 is operating at 25° C., which is in the yellow zone, and the safe setpoint is 22° C., i.e., in the green zone, the system 116 may not suggest an immediate change to 22° C. Instead, the system 116 may suggest a step-wise approach, such as moving from 25° C. to 24° C. in the next adjustment cycle, adhering to the maximum limit.

Thus, within the yellow zone, the system 116 works to correct the set-points to reduce the time the asset 104-2 operates outside the optimal operating conditions, while also ensuring that any adjustments made are gradual and within the maximum allowable limit changes to maintain safety of the asset 104-2 and the occupant comfort.

In yet another example, the red zone may be indicative of the operation of an asset, such as the asset 104-3, within the third range of setpoints. If the current setpoint of an operating parameter of the asset 104-3 falls within the third range of setpoints, the operation of the asset 104-3 is considered to be in the red zone. For example, referring to FIG. 4, if the current setpoint of the asset 104-3 is determined to be within the third range of setpoints, the visual representation 404 may get adjusted in the real-time to indicate the operation of the asset 104-3 in the red zone, for example, by placing an indicator 408-3 in the bar chart 406 that is indicative of the red zone. In other words, the red zone may be characterized by any setpoint that is beyond the hard limits. For example, if the hard limit for temperature setpoint in the HVAC system is set at 30° C., any temperature setpoint above 30° C. would place the HVAC system in the red zone, indicating a condition that requires immediate corrective action to prevent potential damage to the HVAC system.

According to an example implementation of the present subject matter, the system 116 is configured to ensure that the asset 104-3 operates within the safe range of setpoints. In doing so, the system 116 may avoid recommending any setpoint that may place the operation of the asset 104-3 in the red zone, which is beyond the hard limits. This means that the system 116 may not propose any setpoint adjustments that may result in a setpoint that exceeds the predefined safety thresholds. For example, if the HVAC system has a hard limit for indoor temperature set at 32° C. (high hard limit) and 16° C. (low hard limit) to ensure the occupant comfort and safety of the HVAC system, the system 116 would not suggest or implement a temperature setpoint that may cause the indoor temperature to exceed 32° C. or drop below 16° C. For instance, if the current indoor temperature is 31° C., the system 116 may not suggest increasing the setpoint to 33° C., as this may place the HVAC system in the red zone.

According to another example implementation of the present subject matter, the system 116 may be configured to prioritize preventing the asset 104-3 from operating in the red zone. This task of the system 116 may take precedence over the maximum positive and negative change limits, which are the limits on how much the setpoint can be increased or decreased in a single adjustment. If avoiding the red zone requires a change that is larger than the maximum change limit, the system 116 may prioritize keeping the setpoint out of the red zone over adhering to the maximum change limit. For example, the HVAC system may have a maximum positive change limit, say 2° C., to prevent rapid changes that may damage to the HVAC system or discomfort to the occupant. However, if the indoor temperature is at 33° C., which is already in the red zone, the system 116 may prioritize bringing the temperature back within the safe range, even if it requires a temperature change greater than the 2° C. limit. For example, the system 116 may immediately suggest lowering the setpoint by 3° C. to bring the temperature back to 30° C., bypassing the maximum positive change limit because exiting the red zone is the priority.

According to yet another example implementation of the present subject matter, once the system 116 has ensured that the setpoint of the operating parameter of the asset 104-3 is out of the red zone, the system 116 may then apply the maximum change limits to any further adjustments. This means that if the asset 104-3 is currently in the red zone and an adjustment is made that brings the setpoint back within safe range of setpoints, any subsequent adjustments in the setpoints may be made in accordance with the maximum change limits. This is to ensure that once the setpoint of the operating parameter of the asset 104-3 is back within a safe range of setpoints, the setpoints can be adjusted in a controlled and gradual manner, adhering to the predefined maximum change limits. Referring to the HVAC example, after the initial adjustment that brings the temperature out of the red zone, any further adjustments to the temperature setpoint may adhere to the maximum change limit. So, if the HVAC system is currently operating at 30° C. and the desired temperature for the optimal operating conditions for the HVAC system is 25° C., subsequent adjustments in the temperature setpoint may be made in increments of no more than 2° C. at a time until the target temperature is reached.

In an example, the visual representation 404 may also include pop-up windows (not illustrated) that may include more detailed information about the corrective action being taken to bring the setpoint back within the safe range of setpoints. The pop-up window may be generated, for example, when the user hovers over the yellow zone and the red zone of the chart 406.

Thus, by the real-time display of the zone of operation of the assets, situational awareness regarding the operations of the assets may be improved. This allows for immediate identification of the assets operating within safe, cautionary, or dangerous parameters, as indicated by the green, yellow, and red zones, respectively. Also, the present subject matter facilitates quick comprehension of the current setpoints of the assets and their compliance with the prespecified range of setpoints, enabling prompt corrective actions. Furthermore, preventing the assets from operating in the red zone, even if it requires overriding maximum change limits, improves the safety of the assets.

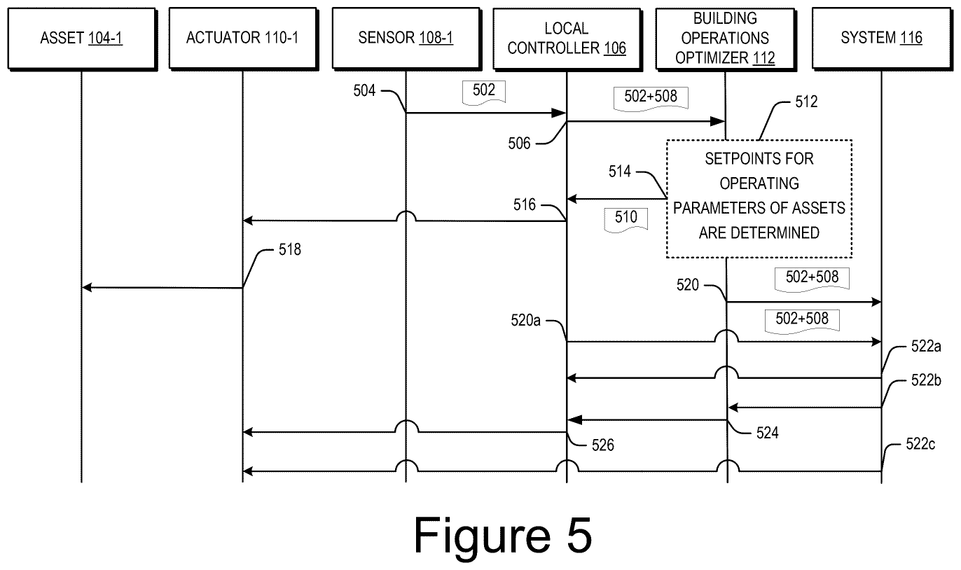

FIG. 5 illustrates a signal flow in a process to manage building operations. As described with reference to FIG. 3, building operations are carried out to maintain and regulate controlled conditions that may include temperature, humidity, air quality, or lightning, within a building, such as the building 102 or a zone of the building 102. The controlled conditions may vary based on various factors such as external weather conditions, occupancy patterns of the building, usage of the building 102, or other factors that influence the controlled conditions of the building 102. To regulate the controlled conditions, operating parameters of one or more assets, such as the asset 104-1 installed within the building 102 or a zone of the building 102 may be controlled by a local controller, such as the local controller 106 in accordance with setpoints. The setpoints define values of the operating parameters to achieve the controlled condition that may be predefined.

In an example implementation of the present subject matter, the one or more sensors, such as the sensor 108-1, installed in the building 102, may sense the operating parameters of the asset 104-1 installed in the building 102, and the controlled conditions within the building 102. The sensor 108-1 may provide data 502 indicative of values of the operating parameters of the asset 104-1 and the controlled conditions to the local controller 106 as represented through signal 504. The local controller 108 may provide the data received from the sensor 108-1 to the optimizer 112 as represented through signal 506. The local controller 106 may also provide data 508 related to factors that influence the controlled conditions of the building 102 such as occupancy patterns and external weather conditions to the optimizer 112 along with data 502 as indicated by the signal 506.

According to an example implementation of the present subject matter, as indicated in block 512, the optimizer 112 may determine the setpoints for the operating parameters of the asset 104-1 in accordance with the factors influencing the controlled conditions within the building 102, such as external weather conditions or occupancy patterns based on the data 502 and data 508 as sensed by the sensor 108-1. The optimizer 112 may determine the setpoints based on AI models utilizing historical data related to past operations of an asset similar to the asset 104-1. The optimizer 112 may provide the setpoints 510 to the local controller 106 as represented through the signal 514.

Based on the setpoints received from the optimizer 112, the local controller 106 controls the operating parameters of the asset 104-1 through a corresponding actuator, such as the actuator 110-1, connected to the asset 104-1 to achieve the predefined controlled conditions within the building 102, which may comprise sending signals to the actuator 110-1 as indicated through the signal 516. The actuator 110-1 may execute physical changes in the setting of the asset 104-1 in accordance with the setpoints of the operating parameters as indicated through signal 518.

To manage building operations, the system 116 monitors the operation of each of the one or more assets 104-1, 104-2, . . . , and 104-n installed in the building 102, such as the asset 104-1, over a period of time to determine a deviation in values of the operating parameters of the asset 104-1 from a corresponding first range of setpoints. The first range of setpoints includes values of the operating parameters of the asset 104-1 predefined by the system 116 for the optimal operating conditions of the asset 104-1.

In an example, to monitor the operation of the asset 104-1, the system 116 may receive the data 502 indicative of a current setpoint of the operating parameters of the asset 106-1 as sensed by the sensor 108-1 either from the optimizer 112 as represented through the signal 520 or from the local controller 106 as represented through the signal 520a. Data 508 related to factors that influence the controlled conditions of the building 102 such as the occupancy patterns and external weather conditions may also be received by the system 118 along with the data 502 either from the optimizer 112 as represented through the signal 520 or from the local controller 106 as represented through the signal 520a. The system 116 may compare the current setpoint of the operating parameters of the asset 104-1 with the corresponding first range of setpoints to determine if the current setpoint of the asset 104-1 is outside the first range of setpoints.

In an example, the system 116 may also determine a plurality of corrective actions that may be applied to bring the current setpoint of the asset 104-1 within the first range of setpoints when the current setpoint of the operating parameters of the asset 104-1 is determined to be beyond the first range of setpoints. The plurality of corrective action may comprise controlling the operating parameters of the asset 104-1, switching off the asset 104-1, or scheduling a maintenance operation to be carried out on the asset 104-1.

The system 116 may initiate a corrective action that may be selected from amongst the plurality of corrective actions based on a zone of operation of the asset 104-1. For example, if the current setpoint of the asset 104-1 is identified to be in the red zone, the system 116 may suggest more aggressive corrective action, such as switching off the asset 104-1 to prevent damage to the asset 1-4-1. This response is due to the red zone indicating that the asset 104-1 is operating beyond the hard limits, which may lead to unsafe conditions or potential harm to the asset 104-1. On the other hand, if the current setpoint is in the yellow zone, which signifies a less urgent situation where the asset 104-1 is not operating in the optimal operating conditions but is not in immediate danger, the system 116 may take less aggressive corrective action. This may include slowly adjusting the setpoints of the asset 104-1 to gradually bring the current setpoint back within the first range of setpoints, corresponding to the green zone. This approach may allow for a more measured response that seeks to restore optimal operating conditions for the asset 104-1 without causing abrupt changes that may affect the safety of the asset 104-1 or occupant comfort.

To initiate a corrective action such as adjusting the current setpoint of the operating parameters of the asset 104-1 or switching off the asset 104-1, the system 116 may instruct the local controller 106 directly as represented through signal 522a or through the optimizer 112 as represented through signal 522b. The optimizer 112 may in turn instruct the local controller 106 to initiate the corrective action as represented through signal 524. The local controller 106 may operate the actuator 110-1 to modify the settings of the asset 104-1 in accordance with the corrective action by sending the signal as represented through signal 526. In another example, the system 116 may operate the actuator 110-1 directly as represented through signal 522c to modify the settings of the asset 104-1 in accordance with the corrective action.

Accordingly, the present subject matter provides the advantage of suggesting corrective actions to maintain the operation of assets within the green zone, which is indicative of safe and efficient operation. By doing so, the safety and longevity of the assets are ensured by preventing the operation of the assets in more extreme conditions represented by the yellow and red zones.

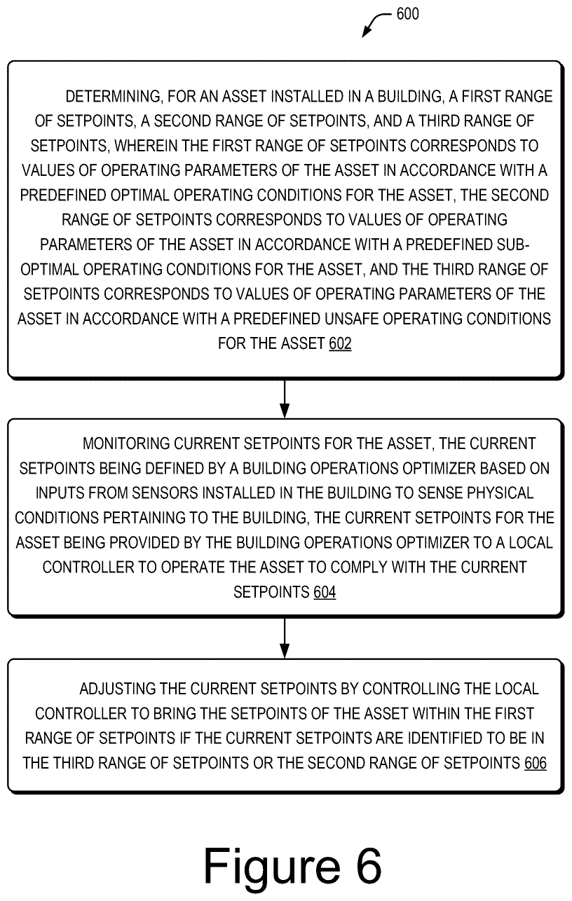

FIG. 6 illustrates a flowchart of method 600 that accounts for the safe operation of an asset 104-1 of a building 102, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer-readable medium. The non-transitory computer-readable medium may include, for example, digital memories, magnetic storage media, such as magnetic disks and magnetic tapes, hard drives, or optically readable digital data storage media. In an example, the method 600 may be performed by the system 116.

Referring to FIG. 6, at block 602, a first range of setpoints, a second range of setpoints, and a third range of setpoints may be determined for an asset, such as the asset 104-1 installed in a building, such as the building 102. The first range of setpoints corresponds to values of operating parameters of the asset 104-1 in accordance with a predefined optimal operating conditions for the asset 104-1. As explained previously, the predefined optimal operating conditions may refer to a specific set of circumstances under which the asset 104-1 operates safely. For example, in the building 102, the optimal operating conditions may refer to a state where setpoints for the operating parameters of the asset 104-1 of the building 102, such as the HVAC system, are within prespecified ranges that ensure the safety of the HVAC system and comfort for occupants of the building. When actual measured values of the operating parameters of the HVAC system, such as current temperature, airflow, and humidity correspond to the prespecified ranges, the HVAC system is considered to be functioning under the optimal operating conditions.

In accordance with an example implementation of the present subject matter, the second range of setpoints corresponds to values of the operating parameters of the asset 104-1 in accordance with a predefined sub-optimal operating conditions for the asset. As explained previously, the asset 104-1 may be considered to be operating within the sub-optimal operating conditions when the operating parameters of the asset 104-1 do not correspond to the predefined criteria for the optimal operating conditions. The sub-optimal operating conditions are characterized by the setpoints of the asset 104-1 that are not within the first range of setpoints but still within a range that does not compromise the safety of the asset 104-1. The third range of setpoints corresponds to values of the operating parameters of the asset 104-1 in accordance with a predefined unsafe operating conditions for the asset 104-1. In an example, the unsafe operating conditions may correspond to scenarios where the operating parameters of the asset 104-1 go even beyond the sub-optimal operating conditions exceeding predefined safety thresholds, leading to risk to the safety of the asset 104-1 or discomfort to the occupants of the building 102.

At block 604, current setpoints for the asset 104-1 are monitored, for example, by the site data processing module 310 of the system 116. As explained previously, the current setpoints are defined by a building operations optimizer, such as the optimizer 112, based on inputs from sensors, such as the sensor 108-1, installed in the building 102 to sense physical conditions pertaining to occupancy and weather conditions in the building 102. For example, the current setpoints for the asset 104-1 are provided by the optimizer 112 over the network 114 to the local controller 106 that operates the asset 104-1 to comply with the current setpoints provided by the optimizer 112.

As explained previously, in an example implementation of the present subject matter, the process of monitoring the operation of the asset 104-1 may involve actively receiving ongoing site data by the site data processing module of the system 116. The site data may be indicative of a real-time operational status of the asset 104-1 and includes data corresponding to the setpoints of the operating parameters of the asset 104-1 as set by the optimizer 112. The site data is collected by the local controller 106 based on input from the sensor 108-1, 108-2, . . . , and 108-n. The local controller 106 collects the data corresponding to the current setpoints of the asset 104-1 from the sensors 108-1, 108-2, . . . , and 108-n, and then transmits this data over the network 114 to the system 116.

Once the data pertaining to the current setpoints for the asset 104-1 is received, the site data processing module 310 of the system 116 proceeds to compare the current setpoints against the prespecified range of setpoints defined for the optimal operating conditions of the asset 104-1. If the site data processing module 310 ascertains that the current setpoints, as defined by the optimizer 112 for the asset 104-1, lie outside of the first range of setpoints, the site data processing module 310 may cause a corrective action to be applied.

At block 606, the current setpoints of the asset 104-1 as provided by the optimizer 112 may be adjusted, for example, by the safety range compliance module 312, as the corrective action. To adjust the current setpoints of the asset 104-1, the local controller 106 may be controlled to bring the setpoints of the asset 104-1 within the first range of setpoints. In accordance with an example implementation of the present subject matter, the corrective action may include issuing commands to the local controller 106 to adjust the current setpoints of the asset 104-1 to bring the setpoints of the asset 104-1 within the first range of the setpoints. In another example, the corrective action may include notifying a building operations manager of the building 102 to intervene and take the requisite actions.

Consequently, the example method 600 facilitates the prevention of setpoint configurations for the asset 104-1 of the building 102 by the optimizer that may damage the asset 104-1 or cause discomfort to the occupants of the building 102. In doing so, the present subject matter effectively addresses safety concerns at an interface where actual physical systems, such as the assets 104-1, 104-2, . . . , and 104-n of the building 102, intersect with the optimization processes of the optimizer 112.

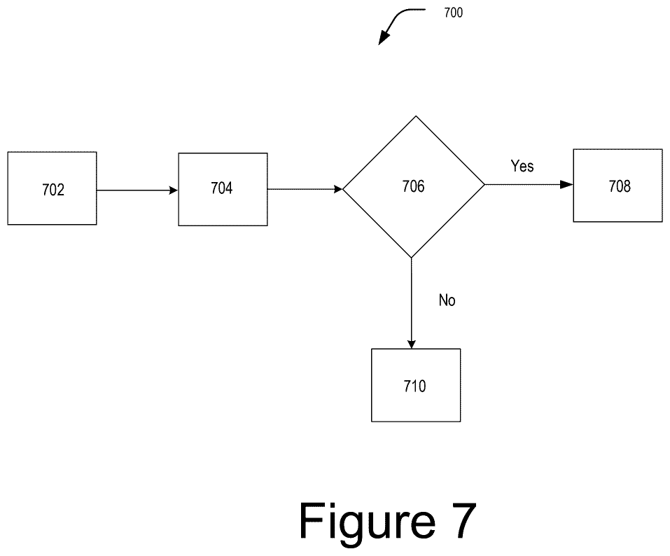

FIG. 7 illustrates a flow diagram of a process 700 of managing setpoint changes in operating parameters of an asset, such as the asset 104-1, installed in a building, such as the building 102, according to an example implementation of the present subject matter. The order in which the above-mentioned process is described is not intended to be construed as a limitation, and some of the described process blocks may be combined in a different order to implement the process, or an alternative process.

Furthermore, the above-mentioned process may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods. In an example, the process 700 may be implemented by the system 116 of FIGS. 1, 2, and 3.

At block 702, data corresponding to the controlled conditions within the building 102 and data corresponding to factors that influence the controlled conditions of the building 102 such as occupancy patterns and external weather conditions may be provided to the optimizer 112 over the network 114, for example, by the local controller 106. In an example, the one or more sensors, such as the sensor 108-1 installed in the building 102 may sense the controlled conditions and the data corresponding to the factors that influence the controlled conditions of the building 102.

At block 704, the optimizer 112 may determine the setpoints based on the data received from the local controller 106 and provide the setpoints to the local controller 106. The local controller 106 may control the operating parameters of the asset 104-1 through the corresponding actuator 110-1 to comply with the setpoints provided by the optimizer 112.

At block 706, the setpoints of the operating parameters of the asset 104-1 as provided by the optimizer 112 may be validated, for example, by comparing the setpoints provided by the optimizer 112 with the corresponding prespecified range of setpoints. The prespecified range of setpoints includes the first range of setpoints, the second range of setpoints, and the third range of setpoints for the asset 104-1 installed in the building 102. The validation of the setpoints provided by the optimizer 112 with the corresponding prespecified range of setpoints is a basic sanity check that may be performed to ascertain if the setpoints provided by the optimizer 112 correspond to values of the operating parameters of the asset 104-1 in accordance with the predefined optimal operating conditions for the asset. If the setpoints provided by the optimizer 112 are determined as validated, i.e., Yes, proceeding to block 708, the system 116 may allow the local controller 106 to set the operating parameters of the asset 104-1 to comply with the setpoints provided by the optimizer 112. For example, the setpoints provided by the optimizer 112 are determined as validated if the setpoints provided by the optimizer 112 falls within the first range of setpoints that correspond to the values of operating parameters of the asset 104-1 in accordance with predefined optimal operating conditions for the asset 104-1.

Accordingly, at block 708, the local controller 106 may operate the actuator 110-1 to modify the settings of the asset 104-1 in accordance with the setpoints provided by the optimizer 112. If the setpoints provided by the optimizer 112 are determined as not validated at block 706, i.e., No, proceeding to block 710, the setpoints provided by the optimizer 112 may be adjusted. As explained previously, to validate that the setpoints of the operating parameters of the asset 104-1 as provided by the optimizer 112 are within the first range of setpoints, the system 116 obtains the site data corresponding to an ongoing operation of the asset 104-1 to identify if the setpoints of the operating parameters of the asset 104-1 are outside the first range of setpoints. The system 116 may obtain data corresponding to the setpoints of the operating parameters of the asset 104-1 as provided by the optimizer 112 by communicating with the local controller 106.

Accordingly, at block 710, the setpoints provided by the optimizer 112 for the operating parameters of the asset 104-1 is adjusted, for example, by the local controller 106, to bring the values of the operating parameters of the asset 104-1 within the safe range of setpoints, for example, the first range of setpoints. The setpoints provided by the optimizer 112 are adjusted to prevent the asset 104-1 from operating under conditions that may compromise the safety of the asset or cause discomfort to the occupants.

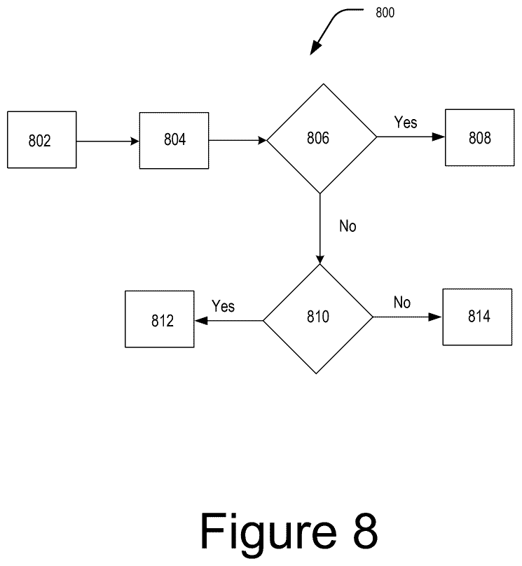

FIG. 8 illustrates a flow diagram of a process of determining a rate of change of setpoints of operating parameters of assets, such as the asset 104-1, installed in a building, such as the building 102, according to an example implementation of the present subject matter. The order in which the above-mentioned process is described is not intended to be construed as a limitation, and some of the described process blocks may be combined in a different order to implement the process, or an alternative process.

Furthermore, the above-mentioned process 800 may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods. In an example, the process 800 may be implemented by the system 116 of FIGS. 1, 2, and 3.

At block 802, data corresponding to a current setpoint of an operating parameter of the asset 104-1 as provided by the optimizer 112 is received, for example, by the site data processing module 310. At block 804, the current setpoint of the operating parameter of the asset 104-1 as provided by the optimizer 112, is compared, for example, by the site data processing module 310, with a prespecified range of setpoints. The prespecified range of setpoints includes a first range of setpoints, a second range of setpoints, or a third range of setpoints. As explained previously, the first range of setpoints corresponds to a value of the operating parameter of the asset 104-1 in accordance with a predefined optimal operating condition for the asset 104-1. The second range of setpoints corresponds to a value of the operating parameter of the asset 104-1 in accordance with a predefined sub-optimal operating condition for the asset 104-1. The third range of setpoints corresponds to a value of the operating parameter of the asset 104-1 in accordance with a predefined unsafe operating condition for the asset 104-1.

At block 806, based on the comparison, an assessment is made as to whether current setpoint of the asset 104-1 as provided by the optimizer 112 corresponds the first range of setpoints. In case, the assessment is in the affirmative, the process 800 proceeds to block 808 where the system 116 may continue to check setpoints adjustments provided by the optimizer 112 in the operating parameter of the asset 104-1 to ensure that the setpoints adjustments provided by the optimizer 112 comply with the maximum positive and negative limits. The maximum positive and negative limits are complied with to prevent sudden, large changes in the setpoints that may damage the asset 104-1 or cause discomfort to the occupants.

However, if at the block 806, it is determined that the current setpoint provided by the optimizer 112 does not correspond to the first range of setpoints, the process 800 proceeds to block 810. At block 810, an assessment is made to check whether the current setpoint as provided by the optimizer 112 corresponds to the second range of setpoints or not.

In case the assessment is in the affirmative, the process 800 proceeds to block 812. It is to be noted that the current setpoint is identified to correspond to the second range of setpoints when the operation of the asset 104-1 enters the yellow zone. As explained previously, the operation of the asset 104-1 in the yellow zone indicates that while the operation of the asset 104-1 may not be in the optimal operating conditions, the asset 104-1 is not in immediate danger or operating unsafely.

At block 812, upon determining that the current setpoint of the asset 104-1 corresponds to the second range of setpoints, the current setpoint may be adjusted, for example, by the safety range compliance module 312, to bring the current setpoint within the first range of setpoints in accordance with a first rate of change. As explained previously, the first rate of change may be a conservative rate of change. Adjusting the setpoint according to the first rate of change may involve a slower adjustment in the setpoint of the operating parameter of the asset 104-1 to gently guide the operating parameter back to the ideal range, for example, the first range of setpoints, without causing abrupt changes that may be uncomfortable for the occupants or strain the asset 104-1.

However, if at the block 810, it is determined that the current setpoint as provided by the optimizer 112 does not correspond to the second range of setpoints, the current setpoint is identified to be corresponding to the third range of setpoints, and accordingly the process 800 move to block 814.

At block 814, as the current temperature setpoint is determined to be within the third range of setpoints, the current setpoint is adjusted at a second rate of change to bring the setpoint back towards the first range of setpoints. As explained previously, the second rate of change may be higher than the first rate of change and lower than the maximum change limit.

Thus, determining the rate of change of the setpoints of the operating parameter of the asset 104-1 in accordance with the values of the current setpoint provides the advantage of ensuring a smooth transition in the operation of the assets 104-1 from one zone to another, which may enhance the occupant comfort and prevent stress on asset 104-1.

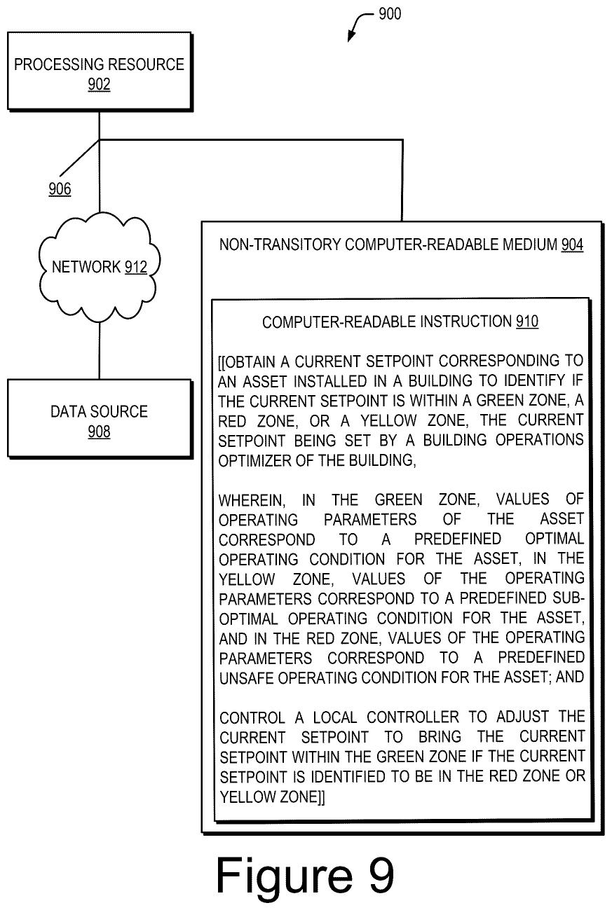

FIG. 9 illustrates a computing environment 900 for managing building operations, according to an example. In an example implementation, the computing environment 900 may comprise a computing device, such as the above-described system 116. The computing environment 900 includes a processing resource 902 communicatively coupled to the non-transitory computer-readable medium 904 through a communication link 906.

In an example, the processing resource 902 may be a processor of the computing device, such as the processor 202 of the system 116, that fetches and executes computer-readable instructions from the non-transitory computer-readable medium 904.

The non-transitory computer-readable medium 904 can be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 can access the non-transitory computer-readable medium 904 through a network 912. The network 912 may be a single network or a combination of multiple networks and may use a variety of different communication protocols.

The processing resource 902 and the non-transitory computer-readable medium 904 may also be communicatively coupled to data sources 908. In an example implementation, the non-transitory computer-readable medium 904 comprises executable instructions 910 for managing the building operations. Building operations are performed to maintain and regulate the controlled conditions, such as temperature, humidity, air quality, or lightning within a building, such as the building 102.

In an example, the instructions 910 cause the processing resource 902 to monitor operation of assets, such as the asset 104-1, installed in the building 102 to obtain a current setpoint of an operating parameter of an asset, such as the asset 104-1 installed in the building 102 to identify if the current setpoint of the asset 104-1 is within a green zone, a red zone, or a yellow zone. As explained previously, the green zone represents a range of setpoints where the asset 104-1 operates in accordance with predefined optimal operating conditions for the asset 104-1, ensuring efficiency, safety, and longevity of the asset 104-1. The red zone indicates that the asset 104-1 is operating beyond predefined safety thresholds, which may lead to unsafe conditions or potential damage to the asset 104-1. The yellow zone is an intermediate state where the asset 104-1 is not operating in accordance with predefined optimal operating conditions for the asset 104-1 but still within a range that does not compromise the safety of the asset 104-1.

In an example, to obtain the current setpoint of the operating parameter of the asset 104-1, the instructions 910 may cause the processing resource 902 to receive data indicative of the current setpoint of the operating parameters of the asset 104-1 from the local controller 106 as provided by the optimizer 112. In an example, the operating parameter of the asset 104-1 may include the supply water, the air temperature, and/or the air speed, among others, associated with various components of the asset 104-1, that may be sensed, for example, by a corresponding sensor, such as the sensor 108-1.

Having obtained the current setpoint of the asset 104-1, in an example, the instructions 910 cause the processing resource 902 to control the local controller 106 to adjust the current setpoint of the operating parameter of the asset 104-1 to bring the setpoint of the asset 104-1 within the green zone if the current setpoint is identified to be in the red zone or the yellow zone. For example, if the processing resource 902 receives data indicating that a current temperature setpoint for the HVAC system is 25° C., which falls within the yellow zone, the instructions 910 may cause the processing resource 902 to signal the local controller 106 to adjust the temperature setpoint of the HVAC system back into the green zone, say to 22° C., to optimize comfort and energy efficiency. If the current temperature setpoint of the HVAC system were found to be at 27° C., which is in the red zone, the instructions 910 may prompt an even more urgent adjustment to bring the temperature setpoint back into the green zone to ensure the safety of the HVAC system.

In an example, to adjust the current setpoint of the operating parameter of the asset 104-1 to bring the setpoint of the asset 104-1 within the green zone, the instructions 910 cause the processing resource 902 to override commands to the local controller 106 provided by the optimizer 112. Herein, to adjust the current setpoint, the processing resource 902 changes the current setpoint in accordance with a maximum change limit predefined for the asset 104-1. In an example, the maximum change limit defines a maximum allowable adjustment to the setpoints within a given time frame.

In another example, the instructions 910 cause the processing resource 902 to cause a display of a visual representation in the control room of the building 102 depicting the current setpoint in either the green zone, yellow zone, or red zone. This may allow for the real-time monitoring of the zone of operation of the asset 104-1 and intervention based on the zone of operation of the asset 104-1. In yet another example, the instructions 910 cause the processing resource 902 to generate an alert for the building operations manager if the current setpoint is identified to be deviating from the green zone. The alert may include a corrective action as a recommendation to the building operations manager to address the issue and return the setpoint to the desired green zone. In an example, recommended corrective action for the building operations manager may be to test sensors coupled with the local controller when the current setpoints are identified to be in the red zone.

In yet another example, the instructions 910 cause the processing resource 902 to adjust the setpoint of the asset 104-1 at a first rate of change to bring it back to the green zone if the current setpoint is identified to be in the yellow zone. If the current setpoint is identified to be in the red zone, the instructions 910 cause the processing resource 902 to adjust the setpoint at a second rate of change to bring the setpoint of the asset 104-1 into the green zone. As explained previously, the second rate of change may be faster than the first rate of change and lower than the maximum change limit.

Thus, the methods and systems of the present subject matter provide for managing building operations. Although implementations of managing building operations have been described in a language specific to structural features and/or methods, it is to be understood that the appended claims are not necessarily limited to the specific features or methods described. Rather, the specific features and methods are disclosed as example implementations of managing building operations.

What is claimed is:

1. A method for managing building operations, comprising:
determining, for an asset installed in a building, a first range of setpoints, a second range of setpoints, and a third range of setpoints, wherein the first range of setpoints corresponds to values of operating parameters of the asset in accordance with a predefined optimal operating conditions for the asset, the second range of setpoints corresponds to values of operating parameters of the asset in accordance with a predefined sub-optimal operating conditions for the asset, and the third range of setpoints corresponds to values of operating parameters of the asset in accordance with a predefined unsafe operating conditions for the asset;
monitoring current setpoints for the asset, the current setpoints being defined by a building operations optimizer based on inputs from sensors installed in the building to sense physical conditions pertaining to the building, the current setpoints for the asset being provided by the building operations optimizer to a local controller to operate the asset to comply with the current setpoints; and
adjusting the current setpoints by controlling the local controller to bring the setpoints of the asset within the first range of setpoints if the current setpoints are identified to be in the third range of setpoints or second range of setpoints.

2. The method of claim 1, wherein adjusting the current setpoints comprises overriding commands to the local controller by the building operations optimizer.

3. The method of claim 1, wherein adjusting the current setpoints comprises changing the current setpoints in accordance with a maximum change limit predefined for the asset, the maximum change limit defining a maximum allowable adjustment to the setpoints within a given time frame.

4. The method of claim 3, further comprising:
based on the inputs from sensors, determining if the current setpoints of the asset correspond to the second range of setpoints and adjusting the current setpoints to bring the current setpoints within the first range of setpoints in accordance with a first rate of change; or
determining if the current setpoints of the asset correspond to the third range of setpoints and adjusting the current setpoints to bring the current setpoints within the first range of setpoints in accordance with a second rate of change,
the second rate of change being higher than the first rate of change and lower than the maximum change limit.

5. The method of claim 1, further comprising reading the current setpoint updated over a period of time.

6. The method of claim 1, further comprising sensing at least one of ambient temperature, ambient humidity, and occupancy levels of the building.

7. The method of claim 1, further comprising:
displaying, in a control room of the building, the current setpoints in either a green zone, yellow zone, or red zone, the red zone being indicative of operation of the asset within the third range of setpoints, the green zone being indicative of the operation of the asset within the first range of setpoints, and the yellow zone being indicative of the operation of the asset between the second range of setpoints and the third range of setpoints.

8. A system to manage building operations, comprising:
a processor to:
obtain a range of setpoints for an asset installed in a building, wherein the predefined range of the setpoints includes a first range of setpoints, a second range of setpoints, and a third range of setpoints, wherein the first range of setpoints corresponds to values of operating parameters of the asset in accordance with a predefined optimal operating conditions for the asset, the second range of setpoints corresponds to values of operating parameters of the asset in accordance with a predefined sub-optimal operating conditions for the asset, and the third range of setpoints corresponds to values of operating parameters of the asset in accordance with a predefined unsafe operating conditions for the asset;
obtain site data corresponding to an ongoing operation of the asset to identify if a current setpoint of the asset is outside the first range of setpoints, the current setpoint for the asset being determined by a building operations optimizer coupled to the asset to operate the asset to in accordance with the current setpoint; and
apply a corrective action to bring the current setpoint of the asset within the first range of setpoints when the current setpoint is beyond the first range of setpoints, wherein applying the corrective action comprises overriding the building operations optimizer.

9. The system of claim 8, wherein, to apply the corrective action, the processor is to adjust the current setpoint to bring the current setpoint within the first range of setpoints in accordance with a maximum change limit predefined for the asset, the maximum change limit being a maximum allowable change to setpoints within a given time frame.

10. The system of claim 9, wherein the processor is to:
based on the site data corresponding to the ongoing operation of the asset, determine if the current setpoint of the asset corresponds to the second range of setpoints and adjust the current setpoint to bring the current setpoint within the first range of setpoints in accordance with a first rate of change; or
determine if the current setpoint of the asset corresponds to the third range of setpoints and adjust the current setpoint to bring the current setpoint within the first range of setpoints in accordance with a second rate of change,
the second rate of change being higher than the first rate of change and lower than the maximum change limit.

11. The system of claim 8, wherein the processor is to update the predefined range of setpoints based on changes in environmental conditions.

12. The system of claim 8, wherein the processor is to update the predefined range of setpoints based on changes in building usage patterns.

13. A non-transitory computer-readable medium comprising instructions executable by a processing resource to:
obtain a current setpoint corresponding to an asset installed in a building to identify if the current setpoint is within a green zone, a red zone, or a yellow zone, the current setpoint being set by a building operations optimizer of the building,
wherein, in the green zone, values of operating parameters of the asset correspond to a predefined optimal operating condition for the asset, in the yellow zone, values of the operating parameters correspond to a predefined sub-optimal operating condition for the asset, and in the red zone, values of the operating parameters correspond to a predefined unsafe operating condition for the asset; and
control a local controller to adjust the current setpoint to bring the current setpoint within the green zone if the current setpoint is identified to be in the red zone or yellow zone.

14. The non-transitory computer-readable medium as claimed in claim 13, further comprising instructions executable by the processing resource to:
override commands to the local controller by the building operations optimizer to adjust the current setpoints to bring the setpoints out of the red zone,
wherein to adjust the current setpoints, the processing resource is to change the current setpoints in accordance with a maximum change limit predefined for the asset, the maximum change limit defining a maximum allowable adjustment to the setpoints within a given time frame.

15. The non-transitory computer-readable medium as claimed in claim 13, wherein the non-transitory computer-readable medium further comprises instructions executable by the processing resource to obtain an updated value of the current setpoint when the current setpoint is reset by the building operations optimizer of the building.

16. The non-transitory computer-readable medium as claimed in claim 13, further comprising instructions executable by the processing resource to determine at least one of ambient temperature, ambient humidity, and occupancy levels of the building.

17. The non-transitory computer-readable medium as claimed in claim 13, further comprising instructions executable by the processing resource to cause a display of a visual representation depicting the current setpoints in either the green zone, yellow zone, or red zone.

18. The non-transitory computer-readable medium as claimed in claim 13, further comprising instructions executable by the processing resource to generate an alert for a building operations manager if the current setpoints are identified to be deviating from the green zone.

19. The non-transitory computer-readable medium as claimed in claim 13, further comprising instructions executable by the processing resource to generate a recommendation for the building operations manager to test sensors coupled with the local controller when the current setpoints are identified to be in the red zone.

20. The non-transitory computer-readable medium as claimed in claim 14, further comprising instructions executable by the processing resource to:
based on the site data corresponding to the ongoing operation of the asset, determine if the current setpoint of the asset corresponds to the yellow zone and adjust the current setpoint to bring the current setpoint within the green zone in accordance with a first rate of change; or
determine if the current setpoint of the asset corresponds to the red zone and adjust the current setpoint to bring the current setpoint within the green zone in accordance with a second rate of change,
the second rate of change being higher than the first rate of change and lower than the maximum change limit.
